(19) United States
(12) Patent Application Publication
(10) Pub. No.: US 2016/0231637 A1
(43) Pub. Date: Aug. 11, 2016

(54) INFRARED FOCUSING DEVICE

(71) Applicant: SHARP KABUSHIKI KAISHA, Osaka (JP)

(72) Inventors: Eiji SATOH, Osaka (JP); Kiyoshi MINOURA, Osaka (JP); Tomoko TERANISHI, Osaka (JP); Takuma TOMOTOSHI, Osaka (JP)

(73) Assignee: Sharp Kabushiki Kaisha, Osaka (JP)

(21) Appl. No.: 15/022,492

(22) PCT Filed: Aug. 8, 2014
(86) PCT No.: PCT/JP2014/071069

§ 371 Date: Mar. 16, 2016

(30) Foreign Application Priority Data
Sep. 20, 2013 (JP) 2013-196031

(51) Int. Cl. G02F 1/17; E06B 9/24

(52) U.S. Cl. CPC G02F 1/172; E06B 9/24; G02F 2203/11; E06B 2009/2417; E06B 2009/247

(57) ABSTRACT

An infrared dimming apparatus of the present invention includes an automatic control circuit that controls switching in a dimming cell between an infrared reflective state and an infrared transmissive state in accordance with a predetermined time schedule.

### TECHNICAL FIELD

The present invention relates to an infrared dimming apparatus that controls switching between an infrared reflective state and an infrared transmissive state.

### BACKGROUND ART

Patent Document 1, for example, discloses technology that switches between an infrared reflective state and an infrared transmissive state. Patent Document 1 discloses a technology that, in cells that have a fluid host in which dipole particles have been suspended, switches between an infrared reflective state (FIG. 17) that is obtained by scattering the dipole particles and an infrared transmissive state (FIG. 18) that is obtained by electrically aligning the dipole particles.

### RELATED ART DOCUMENT

### Patent Document

Patent Document 1: Publication of Japanese Laid-Open and Examined Applications “Japanese Examined Patent Application No. S45-12718 (Published on May 8, 1970)”

### SUMMARY OF THE INVENTION

### Problems to be Solved by the Invention

However, in the above-mentioned conventional technology, it is necessary to either increase the thickness of the cell or to add a large quantity of dipole particles to the liquid host in order to adequately prevent light from passing directly through the cell. By so doing, it is possible to adequately scatter light in the cell during periods in which infrared rays are being reflected; thus, it is possible to adequately prevent light from passing directly through the cell. However, problems can arise in which the light scattered within the cell heats up the cell itself, thereby causing infrared light to be emitted from the cell in an undesired direction.

Therefore, when a conventional light control device is configured so as to be attached to a window of a house and to control the reflection and transmission of infrared light, even when the infrared light is reflected, there is a possibility that infrared light may be emitted from the cell in an undesired direction, infrared light may be unintentionally emitted within the house, and the temperature within the house may increase.

The present invention was made in light of the above-mentioned problems. An object of the present invention is to provide an infrared dimming apparatus that, by reliably reflecting infrared light during infrared reflecting periods, does not cause the cells to warm up and does not emit infrared light from the cells in an undesired direction.

### Means for Solving the Problems

In order to resolve the above-mentioned problems, an infrared dimming apparatus according to one aspect of the present invention includes: a dimming layer including a plurality of shape-anisotropic members that are disposed between a pair of substrates opposing each other and that have reflective characteristics with respect to infrared light, so as to adjust transmittance of received infrared light; and a state switching control unit that applies a voltage to the dimming layer to change an area of the shape-anisotropic member projected onto the pair of substrates, so as to control switching between an infrared reflective state and an infrared transmissive state, wherein the state switching control unit controls the switching between the infrared reflective state and the infrared transmissive state in the dimming layer in accordance with a predetermined time schedule.

### Effects of the Invention

According to one aspect, by reliably reflecting infrared light during infrared reflecting periods, the present invention exhibits an effect of appropriately reflecting and transmitting infrared light without allowing the cells to become warmer or emitting infrared light from the cells in an undesired direction.

### BRIEF DESCRIPTION OF THE DRAWINGS

FIG. 1 is a block diagram of a schematic configuration of an infrared light-controlling device according to Embodiment 1 of the present invention.

FIG. 2(a) shows an infrared reflective state, and FIG. 2(b) shows an infrared transmissive state.

FIG. 3(a) shows the progression of light in the configuration in FIG. 2(a), and FIG. 3(b) shows the progression of light in the configuration in FIG. 2(b).

FIG. 4 is a graph that shows the transmission spectra of glass used for measuring, and water and propylene carbonate in a glass cell with a cell thickness of 100 μm.

FIG. 5(a) is a perspective view showing ribs in a grid pattern, and FIG. 5(b) is a perspective view showing island-shaped ribs.

FIGS. 6(a) and 6(b) show examples in which electrodes that apply voltage to shape-anisotropic members are formed so as to be separated from one another.

FIGS. 7(a) to 7(c) are cross-sectional views that show a schematic configuration of an infrared dimming apparatus of Embodiment 2.

FIGS. 8(a) to 8(c) are cross-sectional views that show a schematic configuration of an infrared dimming apparatus of Embodiment 3.

FIG. 9(a) shows the progression of light in the configuration in FIG. 1(a), and FIG. 9(b) shows the progression of light in the configuration in FIG. 1(b).

FIGS. 10(a) and 10(b) are cross-sectional views that show a schematic configuration of an infrared dimming apparatus of Embodiment 4.

FIG. 11 is a plan view showing a schematic configuration of comb-shaped electrodes shown in FIGS. 10(a) and 10(b).

FIG. 12(a) shows the progression of light in the configuration in FIG. 10(a), and FIG. 12(b) shows the progression of light in the configuration in FIG. 10(b).

FIG. 13(a) is a micrograph taken of a flake orientation state in a plan view when a voltage is applied between uniformly-planar electrodes, FIG. 13(b) is a micrograph taken of a flake orientation state in a plan view when the voltage applied between comb-shaped electrodes is relatively low, and FIG. 13(c) is a micrograph taken of a flake orientation state in a plan view when the voltage applied between the comb-shaped electrodes is relatively high.

FIGS. 14(a) to 14(c) are cross-sectional views that show a schematic configuration of an infrared dimming apparatus of Embodiment 5.

FIG. 15(a) shows the progression of light in the configuration in FIG. 14(a), FIG. 15(b) shows the progression of light in the configuration in FIG. 14(b), and FIG. 15(c) shows the progression of light in the configuration in FIG. 14(c).

FIG. 16(a) shows the orientation of liquid crystal molecules and shape-anisotropic members during an infrared reflective state, FIG. 16(c) shows the orientation of the liquid crystal molecules and the shape-anisotropic members during an infrared transmissive state, and FIG. 16(b) shows an orientation state between the orientations of FIGS. 16(a) and 16(c).

FIG. 17 shows an infrared reflective state in a conventional light control device.

FIG. 18 shows an infrared transmissive state in a conventional light control device.

### DETAILED DESCRIPTION OF EMBODIMENTS

### Embodiment 1

An embodiment of the present invention will be explained below.

<Schematic Description of Infrared Dimming Apparatus>

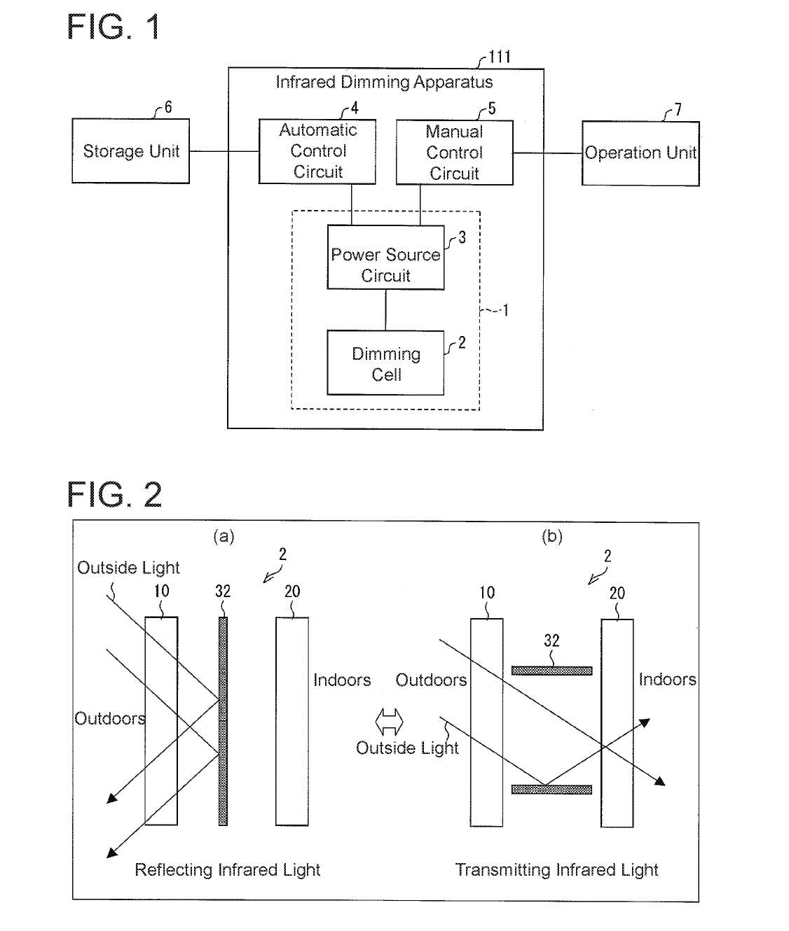

As shown in FIG. 1, an infrared light-controlling device according to the present embodiment includes an infrared dimming apparatus 111 for adjusting the transmittance of infrared light.

The infrared dimming apparatus 11 includes a dimmer panel 1, an automatic control circuit (state switching control unit) 4, and a manual control circuit (state switching control unit) 5.

The dimmer panel 1 includes a dimming cell (dimming layer) 2 that adjusts the transmittance of received infrared light, and a power source circuit 3 for applying a prescribed voltage to the dimming cell 2.

As shown in FIG. 2(a), for example, the dimming cell 2 includes a plurality of shape-anisotropic members 32 that are disposed between a pair of mutually opposing substrates 10, 20 and that reflect infrared light (outside light), and adjust the transmittance of infrared light entering from the substrate 10, which is located outdoors, by controlling the orientation state of the shape-anisotropic members 32. The shape-anisotropic members 32 will be explained in more detail later.

The power source circuit 3 applies voltage for controlling the orientation state of the shape-anisotropic members 32 within the dimming cell 2. The application of voltage by the power source circuit 3 is controlled by control signals from the automatic control circuit 4 and the manual control circuit 5 within the infrared dimming apparatus 111.

The automatic control circuit 4 is configured to control the orientation state of the shape-anisotropic members 32 in accordance with a time schedule stored in the storage unit 6. In other words, the orientation state of the shape-anisotropic members 32 is automatically controlled in accordance with the time schedule stored in the storage unit 6.

Specifically, by controlling the power source circuit 3 and applying voltage to the dimming cell 2, the projected area of the shape-anisotropic members 32 on the pair of substrates 10, 20 is changed, and switching between an infrared reflective state and an infrared transmissive state is controlled. This control is performed in accordance with the above-mentioned time schedule.

The manual control circuit 5 is configured so as to control the orientation state of the shape-anisotropic members 32 in accordance with operation input signals from an operation unit 7. In other words, the orientation state of the shape-anisotropic members 32 is controlled by operations input by a user via the operation unit 7.

The way in which the orientation state of the shape-anisotropic members 32 is controlled will be explained in more detail later.

<Explanation of Principles of Infrared Dimming>

The principles of dimming control of infrared light in the dimming cell 2 will be explained with reference to FIG. 2. The shape-anisotropic members 32 are flake-shaped flake members that reflect infrared light. The dimming cell 2 is installed on a window or the like such that the substrate 10 is disposed outdoors and the substrate 20 is disposed indoors.

FIG. 2(a) shows an infrared reflective state in which infrared light from the outside is reflected by the dimming cell 2. FIG. 2(b) shows an infrared transmissive state in which infrared light from the outside is transmitted by the dimming cell 2.

During the infrared reflective state shown in FIG. 2(a), the shape-anisotropic members 32 are oriented such that the flake surface (infrared reflective surface) of the shape-anisotropic members 32 is substantially parallel to the surfaces of the respective substrates 10, 20. This can be accomplished during the infrared reflective state (light blocking state) by horizontally aligning the shape-anisotropic members 32, which are flake members that reflect infrared light. In this manner, it is possible for light that enters from the outside to be specularly reflected at the flake surface of the shape-anisotropic members 32 in the dimming cell 2, and then efficiently be reflected back toward the light-entering side.

Meanwhile, during the infrared transmissive state shown in FIG. 2(b), the shape-anisotropic members 32 are oriented such that the flake surfaces (infrared reflective surface) of the shape-anisotropic members 32 are arranged in parallel substantially perpendicular to the surfaces of the substrates 10, 20. During the infrared transmissive state, even if infrared light from the outside enters from a direction diagonal with respect to the surface (light-entering side) of the substrate 10, the infrared light is reflected by the flake surface of the shape-anisotropic members 32 in the dimming cell 2 and then enters the indoor substrate 20.

<Description of Dimmer Panel>

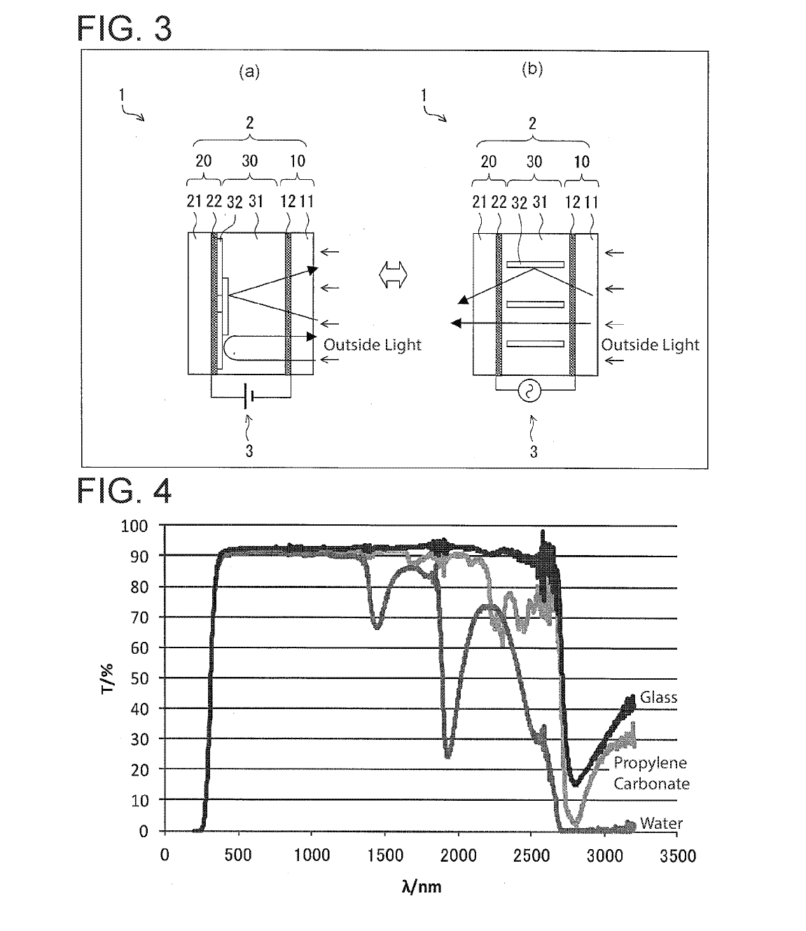

FIGS. 3(a) and 3(b) are cross-sectional views showing a schematic configuration of a dimmer panel 1 according to Embodiment 1. The dimmer panel 1 includes: the dimming cell 2, and the power source circuit 3 that applies voltage to the dimming cell 2.

The dimming cell 2 includes a pair of substrates 10, 20 disposed so as to face each other, and a light modulation layer 30 disposed between this pair of substrates 10, 20. The substrates 10, 20 each include an insulating substrate formed of a transparent glass substrate, for example, and electrodes 12 (first electrode), 22 (second electrode).

The electrode 12 formed on the substrate 10 and the electrode 22 formed on the substrate 20 are formed via transparent conductive films made of ITO (indium tin oxide), IZO (indium zinc oxide), zinc oxide, tin oxide, or the like.

The light modulation layer 30 is provided between the electrodes 12, 22, and includes a medium 31 and a plurality of shape-anisotropic members 32 contained in the medium 31. Voltage is applied to the light modulation layer 30 via the power source circuit 3, which is connected to the electrodes 12, 22, and the light modulation layer 30 changes the transmittance of infrared light that enters the light modulation layer 30 from the outside in accordance with changes in the frequency of the applied voltage. In the present specification, a case in which the frequency of the alternating current voltage is 0 Hz is referred to as “direct current.” The thickness (cell thickness) of the light modulation layer 30 is set by the length in the long-axis direction of the shape-anisotropic members 32, and is set at 80 μm, for example.

<Control of Transmittance of Infrared Light by Light Modulation Layer 30>

Next, a method of controlling the transmittance of infrared light using the light modulation layer 30 will be described in detail. Here, the shape-anisotropic members 32 will be described as being flakes.

When a high frequency voltage (alternating current voltage) with a frequency of 60 Hz, for example, is applied to the light modulation layer 30, as shown in FIG. 3(b), the shape-anisotropic members 32 (hereafter abbreviated as “flakes”) rotate such that the long axes thereof become parallel to the lines of electric force due to forces explained by dielectrophoresis, Coulomb's force, or electrical energy. In other words, the flakes 32 are oriented (hereafter referred to as a vertical orientation) such that the long axes thereof are perpendicular to the substrates 10, 20. As a result, outside light is transmitted by (passes through) the light modulation layer 30, and is emitted into the inside of the house (the left side in the drawings).

Meanwhile, if a low frequency voltage with a frequency of 0.1 Hz, for example, or a direct current voltage (frequency=0 Hz) is applied to the light modulation layer 30, then the flakes, which have a charge, will be attracted toward an electrode having an opposite charge due to forces explained by electrophoresis or Coulomb's force. The flakes, in order to have the most stable orientation, will rotate so as to attach to the substrate 10 or the substrate 20. FIG. 2(a) shows an example in which, when direct current voltage is applied to the light modulation layer 30, the polarity (positive) of the electric charge of the electrode 22 on the substrate 20 and the polarity (negative) of the charge of the flakes are different from each other, and the flakes are oriented so as to attach to the substrate 20. In other words, the flakes are oriented (hereafter also referred to as horizontally oriented) such that the long axes thereof are parallel to the substrates 10, 20. As a result, light that enters the light modulation layer 30 from the substrate 10 is blocked by the flakes; thus, the light is not transmitted by (does not pass through) the light modulation layer 30.

In this manner, the transmittance (amount of transmitted light) of the light entering the light modulation layer 30 from the substrate 10 can be modified by switching the voltage applied to the light modulation layer 30 between a direct current with a frequency of 0 Hz and an alternating current, or between low frequency and high frequency. The frequency at which the flakes horizontally orient (switch to horizontal orientation) is 0 Hz to 0.5 Hz, for example, and the frequency at which the flakes vertically orient (switch to vertical orientation) is 30 Hz to 1 kHz, for example. These frequencies are predetermined by the shape and material of the flakes (shape-anisotropic members 32), the thickness (cell thickness) of the light modulation layer 30, and the like. In other words, in the dimmer panel 1, the transmittance of light (amount of transmitted light) is modified by switching the frequency of the voltage applied to the light modulation layer 30 between a low frequency that is less than or equal to a first threshold and a high frequency that is greater than or equal to a second threshold. In this example, the first threshold can be set to 0.5 Hz and the second threshold can be set to 30 Hz, for example.

When flakes are used as the shape-anisotropic members 32, it is preferable that the thickness thereof be less than or equal to 1 μm, and even more preferable that the thickness be less than or equal to 0.1 μm. It is possible to increase transmittance as the flakes become thinner.

Hereafter, the shape-anisotropic members 32, the electrodes 12, 22, and the medium 31, which are parts of the dimming cell 2, will be explained in detail.

<Shape-anisotropic Members 32>

The shape-anisotropic members 32 will be explained in more detail hereafter.

The shape-anisotropic members 32 are formed of: a substance made of a metal, metal oxide, or the like that reflects light in the infrared region, particularly the near infrared region (780 to 2500 nm) which makes up a large portion of solar radiation energy; a substance in which the above-mentioned substance is covered by a dielectric body; or a substance in which an organic material and an inorganic material have been stacked and that performs interference reflection. Specifically, it is possible to use ITO (indium tin oxide) flakes, a multilayer film of SiO₂ and TiO₂, or the like.

The shape of the shape-anisotropic members 32 is a shape in which it is possible to realize specular reflectance during horizontal orientation (when the infrared reflective surface is oriented so as to be substantially parallel to the surfaces of the substrates 10, 20). It is preferable that the shape-anisotropic members 32 have a diameter of greater than or equal to 250 nm, with greater than or equal to 1 μm being even more preferable. When the diameter is less than or equal to 250 nm, there is a possibility that the members 32 will not be able to adequately reflect light in the infrared region. If the diameter is less than or equal to 1 μm, there is a possibility that more of the light that is reflected during horizontal alignment will be scattered. Specifically, it is preferable to use a flake-shaped object that satisfies the above-mentioned size conditions.

The members 32 may or may not absorb or reflect light in the visible light spectrum. If the members 32 do not absorb or reflect visible light, or in other words, if the members are visibly substantially transparent, the members 32 will be substantially transparent regardless of whether the window is in an infrared blocking state or an infrared transmission state. Such a window may be used as a functional window in current buildings, vehicles, or the like that contain glass.

The specific gravity of the shape-anisotropic members 32 is preferably 11 g/cm³ or less, more preferably 3 g/cm³ or less, and even more preferably equal to the specific gravity of the medium 31. When a core material with a high specific gravity is covered by a resin or the like with a low specific gravity, it is possible to adjust the average specific gravity of the member via the thickness of the cover material. When there is a large difference between the specific gravities of the member and the medium, the member may settle out. It is possible to use an organic material such as an acrylic resin, a polyimide resin, or the like, or an inorganic material such as silicon dioxide, silicon nitride, or the like, for example, as the covering dielectric body. When forming an organic material, it is possible to use a method in which acrylic polymers are made to collect around a metal by irradiating an acrylic monomer solution, in which a central metal has been dispersed, with ultraviolet rays, for example. When forming an inorganic material, it is possible to use a method such as a method that forms silicon dioxide via the well-known sol-gel process.

<Electrodes 12, 22>

Next, the electrodes (transparent electrodes) 12, 22 respectively formed on the substrates 10, 20 will be described.

It is not critical to have the resistance of the electrodes 12, 22 be low since a fast response speed is not a concern. However, in order to realize as high a transmittance of infrared light as possible when the flakes are in a vertical orientation (when the infrared light-reflecting surfaces of the flakes are oriented perpendicular to the surfaces of the substrates 10, 20), it is preferable to use electrodes that absorb little infrared light, and even more preferable to use electrodes that absorb little visible light in order to maintain the ability to function as a window. It is possible to use transparent electrodes used in displays, for example. It is even more preferable to use a material that is used in thin film solar cells. For example, a material that absorbs little infrared light, such as AZO (Al-doped zinc oxide) or ITO with a low carrier density in which the additive amount of tin (Sn) has been adjusted, may be formed on a substrate using sputtering or the like.

<Cell Thickness of Dimming Cell 2>

The cell thickness of the dimming cell 2 will be explained hereafter will reference to FIG. 4.

The cell thickness is set to a thickness necessary for the flake surface to be perpendicular to the substrate surface when the flakes are vertically oriented, or in other words, is a thickness that is larger than the long axis of the flake. At such time, it is possible to obtain a high transmittance of infrared light. In addition, depending on selectivity, the medium itself may absorb light in the infrared region.

FIG. 4 is a graph that shows the transmission spectra of glass used for measuring, and water and propylene carbonate in a glass cell with a cell thickness of 100 μm. Glass has relatively strong absorption in the 2700+ nm range. In other words, while the dimming cell 2 is extremely effective in controlling light in the near infrared spectrum (780 nm to 2500 nm), it cannot control the light absorbed by the medium. That is to say, it is possible to effectively switch between blocking and transmitting infrared rays if the average transmittance of the medium in the 780-2500 nm range is in the preferable range of 30% or higher. It is possible to transmit infrared light to the inside of the home with little loss of infrared light in the window due to absorption by the medium if the average transmittance is in the even more preferable range of 70% or higher. The average transmittance of the medium in the 780 to 2500 nm range depends on the medium material. As seen in FIG. 4, using propylene carbonate is more suitable than using water, for example. Furthermore, in addition to the absorption specific to the material, the cell thickness has an exponential effect on the transmittance. Thus, the cells should be made as thin as possible while still having a cell thickness larger than the long axis of the flakes.

<Medium 31>

Next, the medium 31 included in the dimming cell 2 will be explained in more detail.

As mentioned above, the medium 31 should have weak absorption in the infrared region. When the viscosity of the medium 31 is high, it is possible to maintain the state of the flakes, but there is also a chance that the driving voltage may become high. The present invention is designed to be operated several times in one day. Even if the driving voltage is high, if maintaining the state of the flakes is useful in lowering power consumption, it is possible to use as the medium a material with a high viscosity that can maintain the state of the flakes. In order to increase the viscosity, a medium made of a single substance such as silicone oil, polyethylene glycol or the like, that has a high viscosity may be used, PMMA (polymethyl methacrylate) or the like may be mixed with the above-mentioned medium, or a material such as silica particles that exhibits thixotropic properties may be mixed with the above-mentioned medium.

<Ribs>

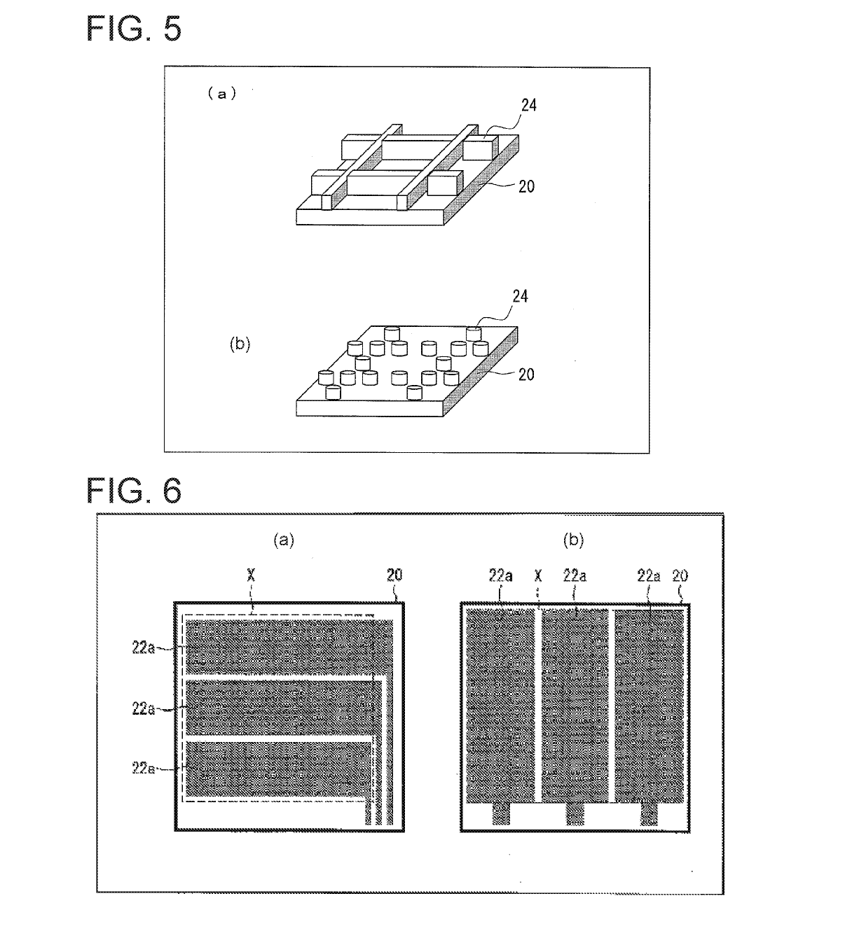

In the dimming cell 2, in order to prevent unevenness in the density of the shape-anisotropic members 32 due to aggregation or the like resulting from gravity and applied voltage, ribs 24 are provided on the substrate 20, as shown in FIGS. 5(a) and 5(b), for example. As shown in FIG. 3, the substrate 20 is the substrate to which the shape-anisotropic members 32 attach.

The shape of the ribs 24 can take any form as long as it prevents the flakes from moving so as to become uneven in an in-plane direction, and may take a grid shape as shown in FIG. 5(a), or may take an island shape as shown in FIG. 5(b), for example. As for the size of the regions partitioned by the ribs 24, it is preferable that all four sides of the regions be 100 μm or that all four sides be 1 mm.

The height of the ribs 24 may be the same as the cell thickness of the flake layer (a layer in which the flakes are oriented) in the dimming cell 2, allowing for the ribs 24 to function as spacers. Alternatively, the height of only a line of ribs that are aligned in the horizontal direction when the substrate is placed upright may be the same as the cell thickness. The latter has the effect of making it easier for the flake mixture to spread across the surface during the step of dripping and attaching during the manufacturing process. By providing such a rib, it is possible to prevent a flake material with a specific gravity higher than the medium from sinking and prevent the distribution of the flake material from becoming uneven on the surface of the substrate when the substrate is placed upright.

It is also possible to sufficiently prevent unevenness in the surface distribution of the flakes by making the height of the ribs 24 the same as the cell thickness of the dimming cells 2 and completely partitioning the flake layer. Particularly in such a case, when providing a thermoplastic resin on the top surface of the rib 24, it is possible to thermally fix the resin to an opposing substrate after bonding. By so doing, when an easily cuttable substrate, such as a plastic substrate, is used, it is possible to easily cut the substrate without the flake mixture leaking. In addition, when using a plastic substrate, it is possible to at least bend the substrate and the substrate is also lightweight; thus it is easy to attach such a substrate to already-existing window glass or the like.

<Modification Example of Electrode 22>

A preferred embodiment of the electrode 22 formed on the substrate 20 will be explained next.

When a material with a low electrical resistance is used as the medium 31 in the dimming cell 2, voltage drops occur moving towards the portion of the electrode surface furthest from the power source; thus, there is a problem in which, even though a prescribed voltage is applied from the power source, a voltage necessary for driving is not applied to the portion of the electrode surface furthest from the power source, making it difficult to operate the flakes. As a countermeasure, it is possible to apply the voltage necessary for driving to the entire flake layer on the electrode surface by dividing the transparent electrodes and reducing the size of each electrode.

For example, as shown in FIG. 6(a), when the electrode 22 is divided (into sections 22a, 22a, 22a) in the horizontal direction, it is possible to perform control so as to vertically align the lower flakes when solar radiation contacts only the lower part of the window during the winter months, for example, thereby transmitting infrared light, and at the same time, horizontally align the upper flakes so as to block heat generated by infrared light from inside the home. Meanwhile, as shown in FIG. 6(b), it is possible to concentrate wiring and the like below the window sash by dividing (into sections 22a, 22a, 22a) the electrode 22 in the vertical direction; thus, it is possible to design a narrower window. A region X surrounded by the dotted line in FIG. 6 represents a region in which the flake solution exists.

<Time Schedule of Flake Orientation>

The above-mentioned infrared dimming apparatus 111 may be configured so as to be manually switched by a user between an infrared reflective state and an infrared transmissive state in the dimming cell 2, or may be configured so as to switch between an infrared reflective state and an infrared transmissive state in the dimming cell 2 in accordance with a predetermined time schedule. In the case of the former, the manual control circuit 5 of the infrared dimming apparatus 111 is used to control the switching; in the case of the latter, the automatic control circuit 4 of the infrared dimming apparatus 111 is used to control the switching.

When the infrared dimming apparatus 111 is attached to the window of a house and controls the transmittance of external infrared light, the following time schedule is an example of one that may be considered: the device 111 performs control so that the device is in an infrared reflective state (FIG. 2(a)) during the day in the summer and is in an infrared transmissive state (FIG. 2(b)) during the night in the summer, and performs control such that the device is in an infrared transmissive state (FIG. 2(b)) during the day in the winter and is in an infrared reflective state (FIG. 2(a)) during the night in the winter.

It is preferable that the above-mentioned time schedule be created as a one year schedule in accordance with the sunrise and sunset for the region in which the infrared dimming apparatus 111 is located. As a result, it is possible for the infrared dimming apparatus 111 to automatically switch between an infrared reflective state and an infrared transmissive state over the course of one year at an appropriate timing.

### Embodiment 2

<Schematic Description of Infrared Dimming Apparatus>

A different embodiment of the present invention will be explained hereafter. For ease of explanation, components having the same functions as those in Embodiment 1 described above are given the same reference characters, and the descriptions thereof are omitted.

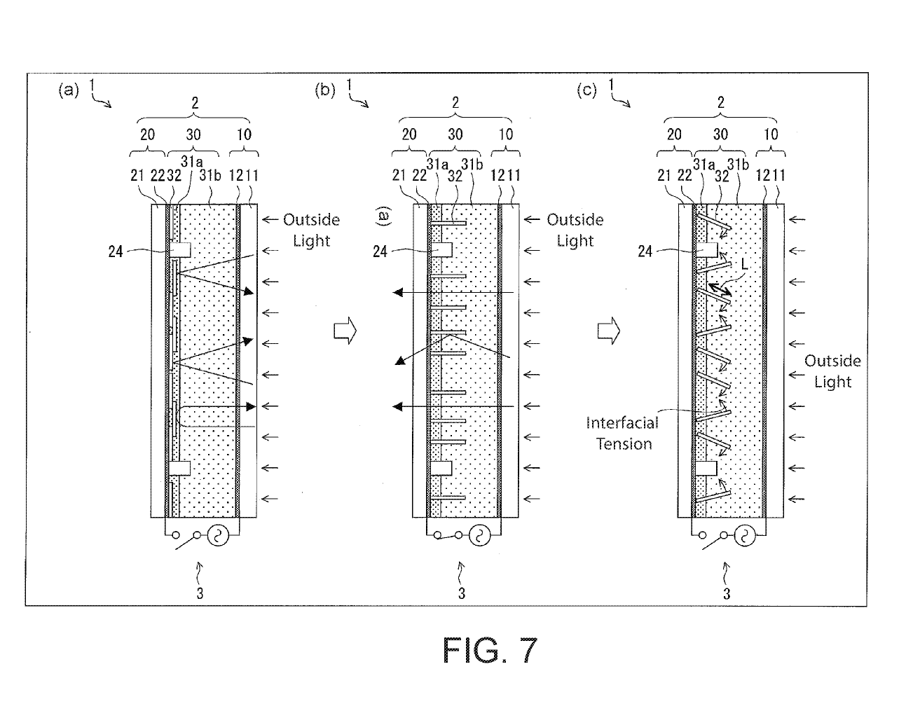

As shown in FIG. 7, a dimmer panel 1 according to the present embodiment includes a polar solvent 31a and a non-polar solvent 31b in place of the medium 31 of Embodiment 1. Substrates 10, 20, which form a part of the dimmer panel 1, respectively include: electrodes 12 (a first electrode), 22 (a second electrode), and insulating substrates 11, 21 formed of a transparent glass substrate, for example.

Furthermore, the shape-anisotropic members 32 have hydrophilic or hydrophobic treatment applied to the surface thereof. A known method can be used for treating the surfaces. The sol-gel method of coating with silicon dioxide can be used as a method of hydrophilic treatment, and dip coating of fluorine resins can be used as a method of hydrophobic treatment, for example. Surface treatment may not be performed on the shape-anisotropic members 32, and the shape-anisotropic members 32 themselves may be formed of hydrophilic members or hydrophobic members. Aluminum oxide can be used for the hydrophilic members, and PET (polyethylene terephthalate) can be used for the hydrophobic members, for example. As mentioned above, the shape-anisotropic members 32 have hydrophilic or hydrophobic characteristics. FIG. 7 shows a case in which the shape-anisotropic members 32 have hydrophilic characteristics.

As mentioned above, the medium is formed of the polar solvent 31a that comes into contact with the hydrophilic substrate 20 and of the non-polar solvent 31b that comes into contact with the hydrophobic substrate 10. The polar solvent 31a and the non-polar solvent 31b are substances that are transparent in the visible light spectrum, and a liquid that generally does not absorb visible light, such a liquid that is colored via a dye, or the like, may be used as the solvents 31a, 31b. It is preferable that the polar solvent 31a and the non-polar solvent 31b have specific weights that are equal to or similar to each other. It is even more preferable that the specific weights of the solvents be equal to or similar to that of the shape-anisotropic members 32.

It is preferable that the polar solvent 31a and the non-polar solvent 31b have low volatility when considering the process of sealing the solvents within the cell (light modulation layer 30). The viscosity of the polar solvent 31a and the non-polar solvent 31b contributes to responsiveness, and it is preferable that the viscosity be 5 mPa·s or less.

In addition, the polar solvent 31a and the non-polar solvent 31b may be formed of a single substance, or a mixture of a plurality of substances. Organic solvents such as water, alcohol, acetone, formamide, or ethylene glycol, an ionic liquid, or a mixture of these or the like can be used as the polar solvent 31a, and silicone oil, aliphatic hydrocarbons, or the like can be used as the non-polar solvent 31b, for example.

As mentioned above, the dimming cell 2 includes: the power source circuit 3, the hydrophilic shape-anisotropic members 32, the polar solvent 31a that contacts the hydrophilic substrate, and the non-polar solvent 31b that contacts the hydrophobic substrate. According to this configuration, the shape-anisotropic members 32 are confined to a fixed narrow region within the polar solvent 31a in a scattered state when a voltage is not applied to the light modulation layer 30. If the shape-anisotropic members 32 are hydrophobic, the shape-anisotropic members 32 are confined to a fixed narrow region within the non-polar solvent 31b in a scattered state when a voltage is not applied to the light modulation layer 30.

It is preferable that the proportion (layer thickness) of the polar solvent 31a be different from the proportion (layer thickness) of the non-polar solvent 31b.

If the shape-anisotropic members 32 are hydrophilic (FIG. 7(a)), then the proportion (layer thickness) of the polar solvent 31a will be smaller than the proportion (layer thickness) of the non-polar solvent 31b, for example. At such time, it is preferable that the layer thickness of the polar solvent 31a be 1 μm or less, and it is even more preferable that the layer thickness be set so as to be the same as the thickness of the shape-anisotropic members 32 or the thickness of several of the shape-anisotropic members 32. The shape-anisotropic members 32 are stably oriented at a location within the narrow polar solvent 31a. When flakes are used as the shape-anisotropic members 32, the flakes are oriented (hereafter also referred to as horizontal oriented) so as to attach to the hydrophilic substrate (substrate 20 in FIG. 7).

If the shape-anisotropic members 32 are hydrophobic, the proportion (layer thickness) of the non-polar solvent 31b will be smaller than the proportion (layer thickness) of the polar solvent 31a. At such time, it is preferable that the layer thickness of the non-polar solvent 31b be 1 μm or less, and it is even more preferable that the layer thickness be set so as to be the same as the thickness of the shape-anisotropic members 32 or the thickness of several of the shape-anisotropic members 32. The shape-anisotropic members 32 are stably oriented in a location within the narrow non-polar solvent 31b. When flakes are used as shape-anisotropic members 32, the flakes are oriented (horizontally oriented) so as to attach to the hydrophobic substrate.

<Control of Transmittance by Light Modulation Layer 30>

Next, a method of controlling the transmittance of light using the light modulation layer 30 will be described in detail. A case in which hydrophilic flakes are used as the shape-anisotropic members 32 will be described below.

As shown in FIG. 7(a), when an alternating current voltage or a direct current voltage is not applied to the light modulation layer 30, the flakes are confined to a fixed narrow region in the polar solvent 31a in a scattered state. In other words, the flakes are stably positioned in the polar solvent 31a (inside the polar solvent 31a ) and are oriented (horizontally oriented) so as to attach to the hydrophilic substrate 20. As a result, light that enters the light modulation layer 30 from the substrate 10 is blocked by the flakes; thus the light is not transmitted by (does not pass through) the light modulation layer 30.

If an alternating current voltage or a direct current voltage is applied to the light modulation layer 30, then, as shown in FIG. 7(b), the flakes rotate such that the long axes thereof become parallel to the lines of electric force due to forces explained by dielectrophoresis, Coulomb's force, or electrical energy. In other words, the flakes are oriented (hereafter also referred to as vertically oriented) such that the long axes thereof are perpendicular to the substrates 10, 20. As a result, light that enters the light modulation layer 30 from the substrate 10 is transmitted by (passes through) the light modulation layer 30 and is emitted toward the inside of the home (the left side of the drawings).

In FIG. 7(b), if voltage is not applied to the light modulation layer 30, then due to interfacial tension that occurs between the flakes and the non-polar solvent 31b, the flakes, as shown in FIG. 7(c), rotate and become oriented (horizontally oriented) such that the long axes thereof become parallel to the substrates 10, 20, thus arriving at the state shown in FIG. 7(a). As a result, light that enters the light modulation layer 30 from the substrate 10 is blocked by the flakes; thus the light is not transmitted by (does not pass through) the light modulation layer 30.

The orientation the flakes will take (such as a vertical orientation, a horizontal orientation, an orientation that falls therebetween, an orientation that is at a prescribed angle from a horizontal orientation, or the like) is determined by the balance between the torque that causes rotation, and the interfacial tension related to the length L (see FIG. 7(c)) of the flakes in the non-polar solvent 31b. When the layer thickness of the polar solvent 31a is sufficiently larger than the thickness of the flakes, the angle of the flakes cannot be completely controlled during the time between no voltage being applied and the flakes starting to enter the non-polar solvent 31b as long as gravity or the like is not used, for example. Meanwhile, by having the layer thickness of the polar solvent 31a be made (i) similar to or smaller (thinner) than the thickness of a flake, or (ii) similar to or smaller (thinner) than the thickness of several flakes when more flakes than are needed to cover the substrate surface during horizontal orientation are added, it is possible to reduce or eliminate the extent to which the flakes can move; thus, the angle of the flakes can be controlled.

One of the benefits of making the layer thickness of the polar solvent 31a sufficiently larger (thicker) than the thickness of the flakes is that it is possible to make the direction normal to the flake surface (a flake surface normal direction) to on average be slightly inclined with respect to the lines of electric force; thus, by applying a voltage, it is possible to reliably obtain the torque to rotate the flakes.

For example, when the flakes are modified with an ionic silane coupling agent or the like, and the flakes are given a positive or negative charge within the medium, it is possible by applying a direct current voltage to use electrophoresis and the horizontal alignment force resulting from interfacial tension; thus, it is possible to further increase response speed.

In this manner, by switching between voltage application and non-voltage application to the light modulation layer 30, it is possible to switch between vertical orientation and horizontal orientation for the flakes, and to modify the transmittance (amount of transmitted light) for light that enters the light modulation layer 30 from the substrate 10.

In particular, when conductive flakes, such as those made of metal, are used, there is the possibility that the flakes will aggregate so as to form a bridge between the electrodes when voltage is applied. By using the above-mentioned configuration of the present embodiment, it is possible to (i) prevent the flakes from actively dispersing within the non-polar solvent when the flakes are hydrophilic and (ii) prevent the flakes from actively dispersing within the polar solvent when the flakes are hydrophobic; thus, it is possible to reduce the amount of occurrences in which the flakes aggregate so as to form a bridge.

When using flakes for the shape-anisotropic members 32, it is preferable that the thickness thereof be less than or equal to 1 μm, and even more preferable that the thickness be less than or equal to 0.1 μm. It possible to increase the transmittance as the flakes become thinner.

In the above description, a configuration was used in which the flakes were confined near a substrate 20 that was opposite to the side from which outside light entered. However, the flakes may be confined near the substrate 10 that is on the side from which outside light enters. In such a case, in the configuration of the dimming cell 2 shown in FIG. 7, the polar solvent 31a may be formed on the substrate 10 side, and the non-polar solvent 31b may be formed on the substrate 20 side. In such a configuration, even if intense infrared light enters the dimming cell 2 as outside light, it is possible to prevent the temperature of the dimming cell 2 itself from increasing since the device is configured such that as little infrared light as possible enters the light modulation layer 30.

In the above-mentioned Embodiment 2, an example was described in which a polar solvent 31a and a non-polar solvent 31b were used in order to horizontally align the flakes and concentrate the flakes near either the substrate 10 or the substrate 20. In Embodiment 3 described below, an example is described in which one end of the flakes is fixed to either the substrate 10 or the substrate 20 in order to horizontally align the flakes and concentrate the flakes near either the substrate 10 or the substrate 20.

### Embodiment 3

Another embodiment of the present invention will be explained below. For ease of explanation, components having the same functions as those in Embodiment 1 described above are given the same reference characters, and the descriptions thereof are omitted.

<Schematic Description of Dimmer Panel>

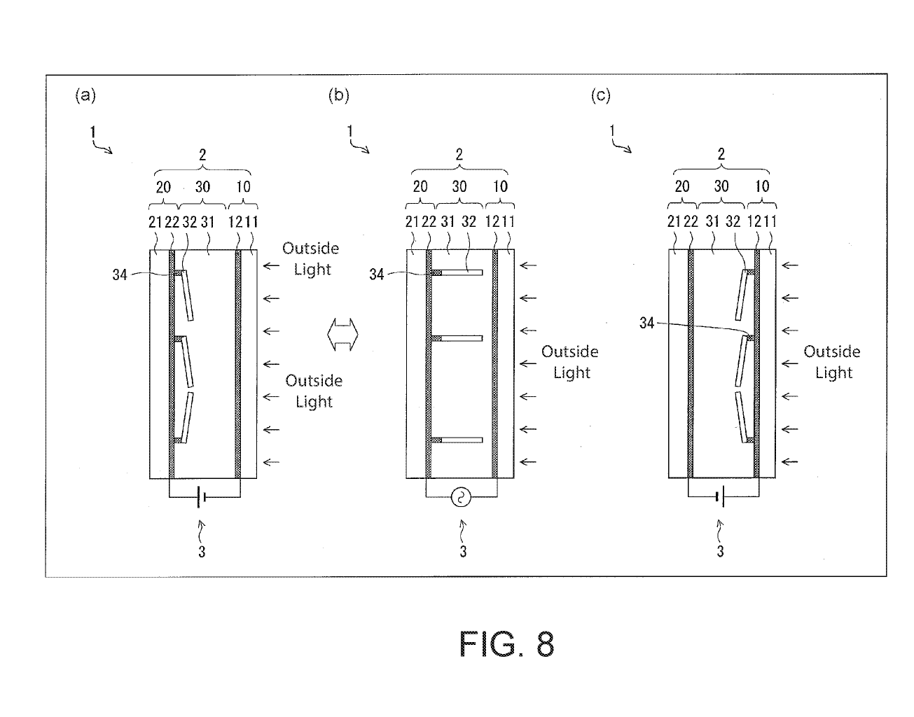

As shown in FIGS. 8(a) and 8(b), a dimmer panel 1 in an infrared dimming apparatus according to the present embodiment differs from Embodiment 1 in that a supporting member 34 made of a resin is formed on the electrode 22 on the substrate 20. Other than this difference, the configuration is the same as that of Embodiment 1.

A portion (one end) of the shape-anisotropic member 32 is connected to the supporting member 34. The shape-anisotropic member 32 has a configuration so as to be able to rotate (modify) using the supporting member 34 as a fulcrum. The shape-anisotropic members 32 and the supporting member 34 may have a one-to-one correspondence, a plurality of shape-anisotropic members 32 may be connected to each of a plurality of supporting members 34, or a plurality of shape-anisotropic members 32 may be connected to one supporting member 34 formed in a uniformly planar shape across the entire surface of the substrate 20.

<Control of Transmittance of Infrared Light by Light Modulation Layer 30>

Next, a method of controlling the transmittance of light using the light modulation layer 30 will be described in detail. An example will be described hereafter in which flakes are used as the shape-anisotropic members 32.

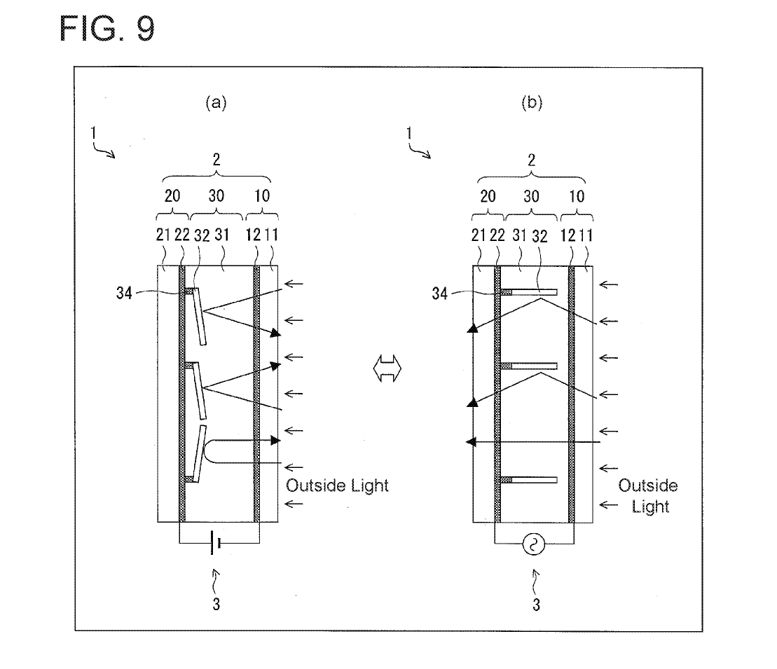

When a high frequency voltage (alternating current voltage) with a frequency of 60 Hz, for example, is applied at 8V to the light modulation layer 30, as shown in FIG. 9(b), the flakes rotate, using the supporting members 34 as a fulcrum, such that the long axes thereof become parallel to the lines of electric force due to forces explained by dielectrophoresis, Coulomb's force, or electrical energy. In other words, the flakes are oriented (hereafter also referred to as vertically oriented) such that the long axes thereof are perpendicular to the substrates 10, 20. As a result, outside light that enters from the substrate 10 is transmitted by (passes through) the light modulation layer 30, is transmitted by the substrate 20, and is emitted into the home (the left side of the drawings).

At such time, if a material that reflects visible light, such as metal pieces including aluminum flakes or the like, is used for the flakes, for example, by having the reflective surface be oriented vertically so as to be perpendicular to the substrates 10, 20, the light received by the light modulation layer 30 passes directly through the light modulation layer 30 or is reflected by the reflective surface of the flakes and propagates towards the surface opposite to the light receiving side (substrate 10 side), or in other words, towards the substrate 20 side.

Meanwhile, when a low frequency voltage with a frequency of 0.1 Hz, for example, or a direct current voltage (frequency=0 Hz) is applied at 8V to the light modulation layer 30, the flakes, which have a charge, will be attracted toward an electrode that has a charge of the opposite polarity due to forces explained by electrophoresis or Coulomb's force. The flakes will then rotate using the supporting members 34 as a fulcrum, and will find the most stable orientation so as to attach to the substrate 10 or the substrate 20. FIG. 9(a) shows an example in which, when direct current voltage is applied to the light modulation layer 30, the polarity of the charge (positive) of the electrode 22 on the substrate 20 and the polarity of the charge (negative) of the flakes are different from each other, and the flakes are oriented in a state so as to attach to the substrate 20. In other words, the flakes are oriented (hereafter also referred to as horizontally oriented) such that the long axes thereof are parallel to the substrates 10, 20. As a result, light that enters the light modulation layer 30 from the substrate 10 is blocked by the flakes; thus the light is not transmitted by (does not pass through) the light modulation layer 30.

In this manner, the transmittance (amount of transmitted light) of the light entering the light modulation layer 30 from the substrate 10 can be modified by switching the voltage applied to the light modulation layer 30 between a direct current with a frequency of 0 Hz and an alternating current, or between low frequency and high frequency. The frequency at which the flakes horizontally orient (switch to horizontal orientation) is 0 Hz to 0.5 Hz, for example, and the frequency at which the flakes vertically orient (switch to vertical orientation) is 30 Hz to 1 kHz, for example. These frequencies are set in advance based on the shape and material of the flakes (shape-anisotropic members 32), thickness (cell thickness) of the light modulation layer 30, and the like. In other words, the infrared dimming apparatus is configured so as to modify the transmittance of light (amount of transmitted light) by switching the frequency of the voltage applied to the light modulation layer 30 between a low frequency that is less than or equal to a first threshold and a high frequency that is greater than or equal to a second threshold. The first threshold can be set to 0.5 Hz and the second threshold can be set to 30 Hz, for example. It is even more preferable to switch between direct current and an alternating current with a frequency of 30 Hz, for example. At such time, the flakes will not be affected by changes in the polarity of the applied voltage; thus, the flakes will be able to regularly achieve a horizontal orientation.

When using flakes for the shape-anisotropic members 32, it is preferable that the thickness thereof be less than or equal to 1 μm, and even more preferable that the thickness be less than or equal to 0.1 μm. It possible to increase the transmittance as the flakes become thinner.

In FIG. 8(a), the supporting members 34 are provided on the electrode 22 of the substrate 20, the minus side of the power source circuit 3 is connected to the electrode 12, and the plus side of the power source circuit 3 is connected to the electrode 22. The present invention is not limited to such a configuration, however, and, as shown in FIG. 8(c), the supporting members 34 may be provided on the electrode 12 of the substrate 10, the minus side of the power source circuit 3 may be connected to the electrode 22, and the plus side of the power source circuit 3 may be connected to the electrode 12. In the configuration shown in FIG. 8(c), the flakes rotate using the supporting members 34 on the substrate 10 as a fulcrum, and are oriented so as to attach to the substrate 10. In FIG. 8, an example was shown in which the polarity of the charge of the flakes was negative. The present invention is not limited to such a configuration, however, and the polarity of the charge of the flakes may be positive.

In the above-mentioned Embodiments 1 to 3, examples were described in which the orientation state of the shape-anisotropic members 32 was controlled using a vertical electric field generated between the electrode 12 of the substrate 10 and the electrode 22 of the substrate 20. In Embodiments 4 and 5 below, examples will be described in which the orientation state of the shape-anisotropic members 32 is controlled by switching between the vertical electric field and a horizontal electric field generated by using comb-shaped electrodes.

### Embodiment 4

Another embodiment of the present invention will be explained below. For ease of explanation, components having the same function as those in Embodiments 1 to 3 described above are given the same reference characters, and the descriptions thereof are omitted.

<Schematic Description of Infrared Dimming Apparatus>

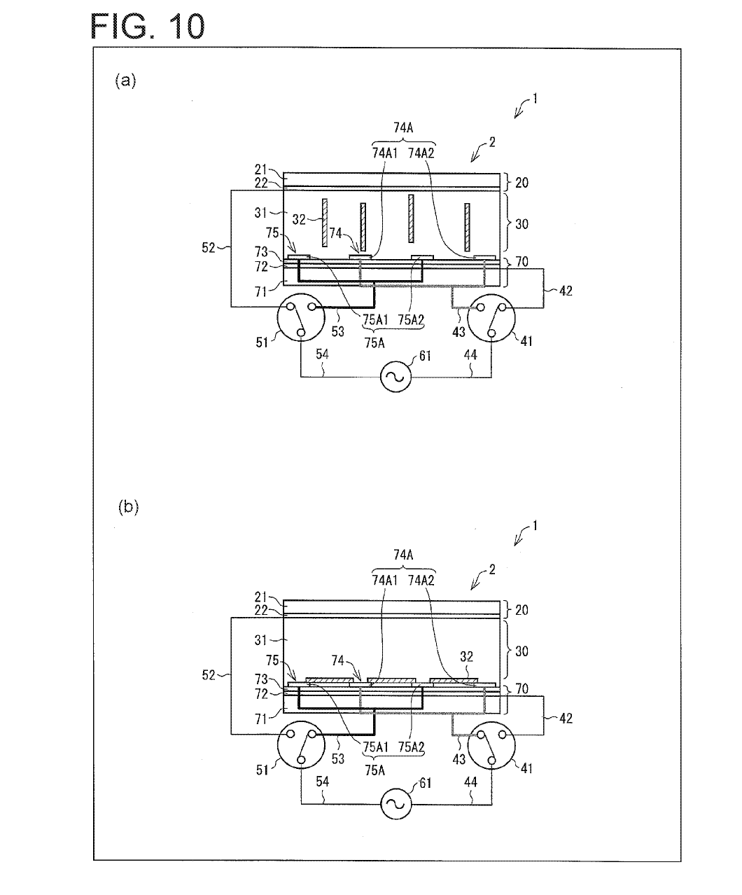

FIGS. 10(a) and 10(b) are cross-sectional views of a schematic configuration of a dimmer panel 1 according to the present embodiment. FIG. 10(a) shows a light transmissive state, and FIG. 10(b) shows a light reflective state.

As shown in FIGS. 10(a) and 10(b), a dimmer panel 1 according to the present embodiment includes a dimming cell 2, and a drive circuit (not shown). The dimmer panel 1 is an infrared dimming apparatus that adjusts the transmittance of outside light received by the dimming cell 2.

The present embodiment is different from Embodiments 1 to 3 in that a substrate 70 is used in place of the substrate 10, which is one of the pair of substrates that form part of the dimming cell 2. Also in the present embodiment, the substrate 20 is disposed on the side in which outside light enters, while the substrate 70 is disposed on the side in which outside light exits.

Therefore, the dimming cell 2 according to the present embodiment includes: a pair of substrates 70, 20 disposed so as to face each other, and a light modulation layer 30 disposed between the pair of substrates 70, 20, and additionally includes relay circuits 41, 51 that switch the direction of the electric field to be applied to the light modulation layer 30 by selecting to which electrodes voltage is applied, and a power source circuit 61.

Hereafter, an example in which the substrate 70 (a first substrate) is disposed on the side in which outside light exits and the substrate 20 (a second substrate) is disposed on the side in which outside light enters, will be mainly described. As mentioned below, however, the present embodiment is not limited to such a configuration.

The dimming cell 2 shown in FIGS. 10(a) and 10(b) has the same configuration as the dimming cell 2 shown in FIGS. 3(a) and 3(b), except that the substrate 70 is used in place of the substrate 10 of the dimming cell 2 of Embodiment 1.

The substrate 70 includes, on an insulating substrate 71, various types of signal lines (scan signal lines, data signal lines, and the like; not shown), switching elements such as TFTs (thin film transistors), and an insulating film, and thereon, a lower electrode that is formed of a uniformly-planar electrode 72 (first electrode), an insulating layer 73, and upper electrodes that are formed of comb-shaped electrodes 74, 75 (second and third electrodes) are layered in this order.

The uniformly-planar electrode 72 is formed in a uniformly planar shape over almost the entire surface of the insulating substrate 71 facing the substrate 20 so as to cover, on the insulating substrate 71, a prescribed region (area surrounded by a sealing member) of the substrate 70.

The insulating layer 73 is formed in a uniformly planar shape over the entire substrate surface of the substrate 70 so as to cover the uniformly-planar electrode 72.

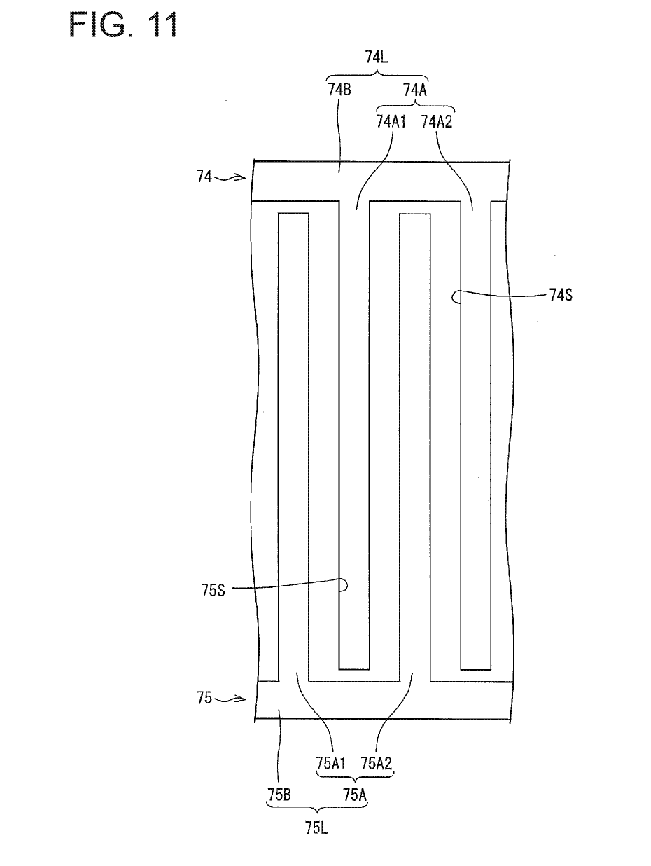

FIG. 11 is a plan view of the substrate 70 showing a schematic configuration of the comb-shaped electrodes 74, 75.

As shown in FIG. 11, the comb-shaped electrode 74 is a comb-shaped electrode that has a patterned electrode section 74L (electrode line) and spaces 74S (where no electrodes are formed). More specifically, the comb-shaped electrode 74 is formed of a trunk electrode 74B (trunk line), and branch electrodes 74A (branch lines) that correspond to the teeth of the comb and that extend from the trunk electrode 74B. p Similarly, the comb-shaped electrode 75 is a comb-shaped electrode that has a patterned electrode section 75L (electrode line) and spaces 75S (where no electrodes are formed). More specifically, the comb-shaped electrode 75 is formed of a trunk electrode 75B (trunk line), and branch electrodes 75A (branch lines) that correspond to the teeth of the comb and that extend from the trunk electrode 75B.

FIGS. 10(a) and 10(b) respectively shown cross-sections of the branch electrodes 74A, 75A as cross-sections of the comb-shaped electrodes 74, 75.

There are no particular restrictions regarding the number (m, n) of the teeth (branch electrodes 74A, 75A) of the comb-shaped electrodes 74, 75 provided in one pixel.

However, the width of the spaces 74S, 75S is set so as to be larger than the width of the branch electrodes 74A, 75A, and, as shown in FIGS. 10(a), 10(b), and 11, the respective comb-shaped electrodes 74, 75, are alternately disposed such that the branch electrodes 74A (74A1, 74A2, . . . 74Am; m is an integer greater than or equal to 1) and the branch electrodes 75A (75A1, 75A2, . . . 75An; n is an integer greater than or equal to 1), which correspond to the teeth of the comb, of the respective comb-shaped electrodes interlock with each other.

Therefore, the number of branch electrodes 74A, 75A is, in reality, determined based on the relationship between the pixel pitch, the width of the respective branch electrodes 74A, 75A, and the gap between adjacent branch electrodes 74A, 75A, and the like.

The respective branch electrodes 74A, 75A may each be linear, V-shaped, or formed in a zigzag pattern.

As an example configuration of the dimming cell 2, when flakes with a particle diameter of 6 μm are used as the shape-anisotropic members 32, a configuration can be used in which the comb-shaped electrodes 74, 75 have an electrode width of 3 μm and an electrode gap of 5 μm, and the cell thickness is 50 μm, for example.

<Relay Circuits 41, 51 and Power Source Circuit 61>

The uniformly-planar electrode 72 of the substrate 70 is electrically connected to the power source circuit 61 via the relay circuit 41 (a first relay circuit). A wiring line 42 for applying voltage to the uniformly-planar electrode 72 is provided between the uniformly-planar electrode 12 and the relay circuit 41.

The uniformly-planar electrode 22 of the substrate 20 is electrically connected to the power source circuit 61 via the relay circuit 51 (a second relay circuit). A wiring line 52 for applying voltage to the uniformly-planar electrode 22 is provided between the uniformly-planar electrode 22 and the relay circuit 51.

In addition, the comb-shaped electrodes 74, 75 are respectively electrically connected to the power source circuit 61 via the relay circuits 41, 51. A wiring line 43 for applying voltage to the comb-shaped electrode 74 is provided between the comb-shaped electrode 74 and the relay circuit 41. A wiring line 53 for applying voltage to the comb-shaped electrode 75 is provided between the comb-shaped electrode 75 and the relay circuit 51.

Furthermore, a wiring line 44 that connects the relay circuit 41 and the power source circuit 61 is provided between the relay circuit 41 and the power source circuit 61. A wiring line 54 that connects the relay circuit 51 and the power source circuit 61 is provided between the relay circuit 51 and the power source circuit 61.

In the present embodiment, the electrodes to which voltage is applied is switched between the uniformly-planar electrodes 72, 22 and the comb-shaped electrodes 74, 75 using the relay circuits 41, 51.

In other words, the relay circuits 41, 51, the power source circuit 61, and the various wiring lines 42 to 44 and 52 to 54 function as electric field application direction changing circuits that change the direction of the electric field applied to the light modulation layer 30, and also function as voltage application units that selectively apply voltage to the respective uniformly-planar electrodes 72, 22 and comb-shaped electrodes 74, 75. In addition, the relay circuits 41, 51 function as switching circuits (selection circuits) that select (switch), from among the uniformly-planar electrodes 72, 22 and the comb-shaped electrodes 74, 75 provided on the substrates 70, 20, the electrodes to which voltage will be applied.

As shown in FIG. 10(a), by switching the relay circuit 41 such that the power source circuit 61 and the uniformly-planar electrode 72 are connected, and switching the relay circuit 51 such that the power source circuit 61 and the uniformly-planar electrode 22 are connected, a vertical electric field is applied to the light modulation layer 30 in a direction perpendicular to the substrates 70, 20, for example.

Meanwhile, as shown in FIG. 10(b), by switching the relay circuit 41 such that the power source circuit 61 is connected to the comb-shaped electrode 74, and switching the relay circuit 51 such that the power source circuit 61 is connected to the comb-shaped electrode 75, a horizontal electric field is applied to the light modulation layer 30 in a direction parallel to the substrates 70, 20.

The relay circuits 41, 51, by receiving switching signals from a signal source (not shown) that switch the electrodes to which voltage is applied, may be switched in accordance with the received switching signals, or may be switched manually, for example.

<Control of Transmittance of Infrared Light by Light Modulation Layer 30>

Next, a method of controlling the transmittance of infrared light using the light modulation layer 30 will be described in detail. An example will be described hereafter in which flakes are used as the shape-anisotropic members 32.

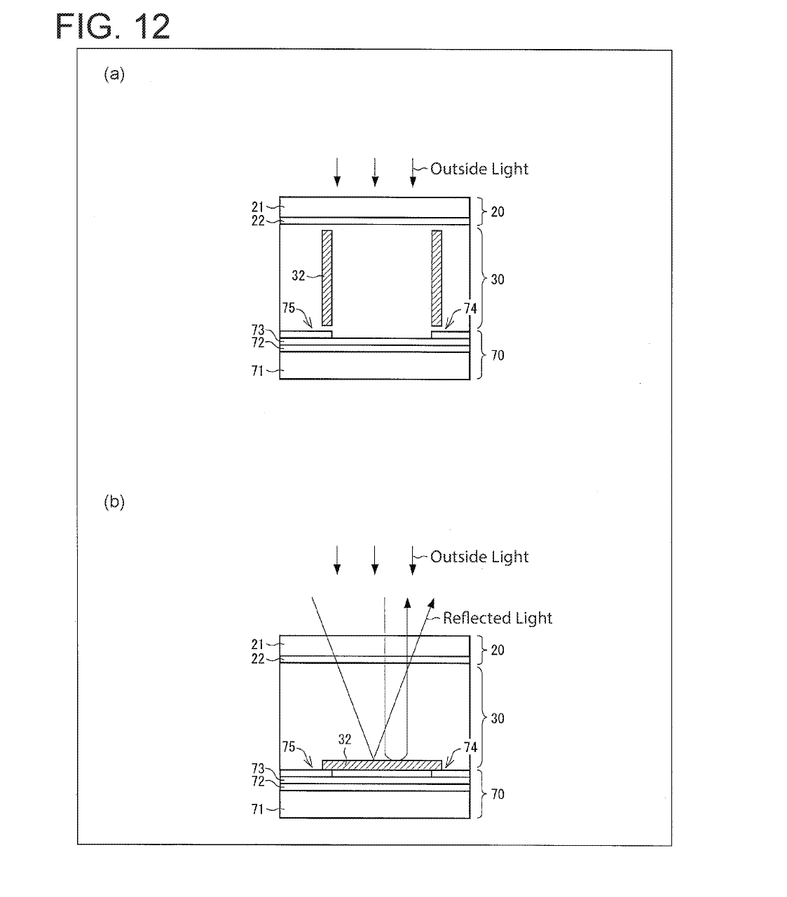

FIG. 12(a) shows the progression of light in the configuration in FIG. 10(a), and FIG. 12(b) shows the progression of light in the configuration in FIG. 10(b). The relay circuits 41, 51 and the power source circuit 61 shown in FIGS. 10(a) and 10(b) are not shown in FIGS. 12(a) and 12(b). FIGS. 10(b) and 12(b) show examples in which the flakes are disposed so as to attach to the substrate 70.

In the present embodiment, by reversibly switching between a vertical electric field generated between the uniformly-planar electrodes 72, 22 and a horizontal electric field generated between the comb-shaped electrodes 74, 75, the orientation of the shape-anisotropic members 32 is reversibly switched.

As shown in FIG. 10(a), if a voltage is applied between the even uniformly-planar electrodes 72, 22 that face each other, the flakes rotate to be in a vertical orientation such that the long axes thereof are parallel to the lines of electric force due to forces explained by dielectrophoresis, Coulomb's force, or electrical energy.

Thus, as shown in FIG. 12(a), outside light that has entered the light modulation layer 30 is transmitted by (passes through) the light modulation layer 30 and is transmitted by the substrate 70.

Meanwhile, as shown in FIG. 10(b), when a voltage at or above a certain amount is applied to the comb-shaped electrodes 74, 75, which interlock with each other and are on the same plane, the flakes enter a horizontal orientation so as to attach to the substrate 10 in the vicinity of the comb-shaped electrodes 74, 75 due to forces explained by dielectrophoresis, Coulomb's force, or electrical energy. Thus, as shown in FIG. 12(b), outside light that has entered the light modulation layer 30 is reflected by the flakes toward where the light entered, or in other words, toward the substrate 70.

As mentioned above, FIG. 12(b) shows a configuration in which the flakes are oriented so as to attach to the substrate 70. The present invention is not limited to such a configuration, however.

When the dimmer panel 1 with the above-mentioned configuration is installed in a window in a home and is used as an infrared dimming apparatus, as shown in FIG. 12(b), when infrared light is intense, there is the possibility in a configuration in which the flakes are attached to the inside of the home, that the inside of the light modulation layer 30 will be heated by the received infrared light. In such a case, by aligning the flakes so as to attach on the substrate 20 side, or in other words, on the side in which the infrared light is being received, it is possible to prevent the infrared light from entering the light modulation layer 30; thus, it is possible to avoid a situation in which the light modulation layer 30 overheats.

### Modification Example of Embodiment 4

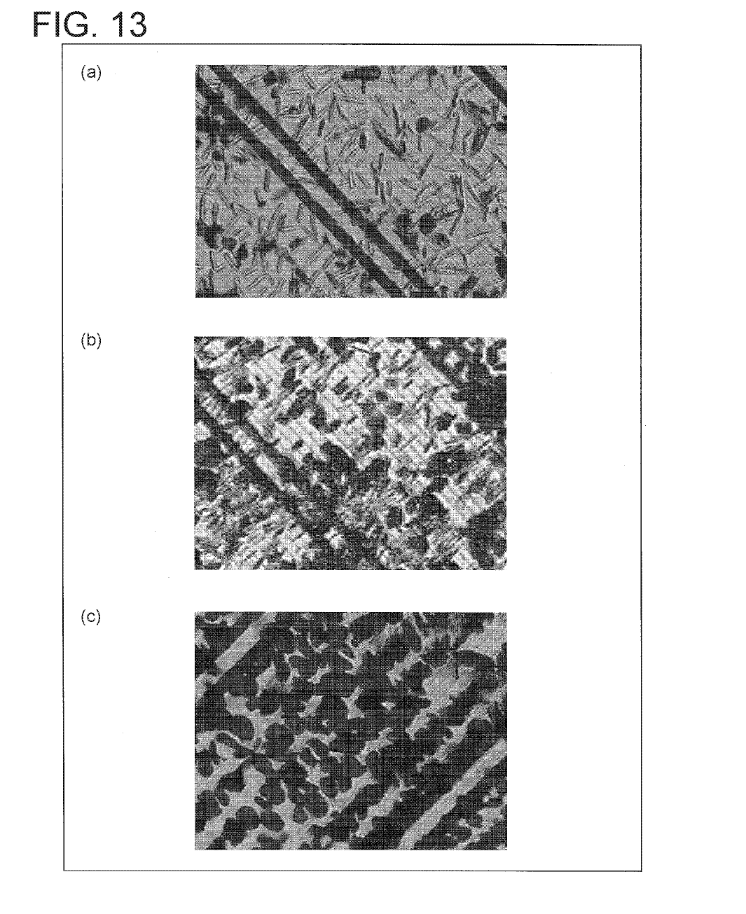

A modification example of Embodiment 4 will be explained hereafter with reference to FIGS. 10 and 13.

FIG. 13(a) is a micrograph taken of a flake orientation state in a plan view when a voltage is applied between the uniformly-planar electrodes 72, 22, FIG. 13(b) is a micrograph taken of a flake orientation state in a plan view when the voltage applied between the comb-shaped electrodes 74, 75 is relatively low, and FIG. 13(c) is a micrograph taken of a flake orientation state in a plan view when the voltage applied between the comb-shaped electrodes 74, 75 is relatively high.

Propylene carbonate was used as the medium 31, aluminum flakes having a diameter of 6 μm and a thickness of 0.1 μm were used as the shape-anisotropic members 32, and the cell thickness was set at 79 μm. The uniformly planar electrodes 72, 22 were made of ITO having a thickness of 1000 Å, the insulating layer was made of silicon nitride having a thickness of 1000 Å, and the comb-shaped electrodes 74, 75 were made of ITO having a thickness of 1000 Å. The widths of the comb-shaped electrodes 74, 75 were respectively set at 3 μm. The electrode gap between adjacent branch electrodes 74A, 75A was set at 5 μm (see FIG. 10).

In FIG. 13(a), an alternating current voltage (vertical electric field) of 3V was applied between the uniformly planar electrodes 72, 22. In FIG. 13(b), the relay circuits 41, 51 were switched, and an alternating current voltage (horizontal electric field) of 0.2 V/μm was applied between the comb-shaped electrodes 74, 75. In FIG. 13(c), an alternating current voltage (a horizontal electric field) of 0.4V/μm was applied between the comb-shaped electrodes 74, 75. The frequency in all cases was 60 Hz.

As shown in FIG. 13(a), when voltage is applied between the uniformly-planar electrodes 72, 22, as mentioned above, it is possible to increase transmissivity as the shape-anisotropic members 32, or in this case, the flakes, become thinner, with this being done in consideration of the fact that the end faces of the flakes are visible.

<Potential of Respective Electrodes When Flakes are Vertically Oriented>

Taking into consideration voltage drops in the insulating layer 73 and the light modulation layer 30, which is a driven layer, for example, the potential of the comb-shaped electrodes 74, 75 with respect to the uniformly-planar electrodes 72, 22 in a state when the flakes are vertically oriented can be set such that the comb-shaped electrodes 74, 75 are at the same level as areas in the same plane where the comb-shaped electrodes 74, 75 are not present, for example.

As a different method, the potential of the comb-shaped electrodes 74, 75 can be insulated without being set to a specific potential. At such time, differences in potential are not generated near the conductive comb-shaped electrodes 74, 75, and lines of electric force are formed that are substantially similar to those generated when the comb-shaped electrodes 74, 75 are absent.

<Potential of Respective Electrodes When Flakes are Horizontally Oriented>

The potential of the comb-shaped electrodes 74, 75 with respect to the uniformly-planar electrodes 72, 22 when the flakes are horizontally oriented can be set to a midpoint value between the values of the potentials, such as 0V, for example, applied to the comb-shaped electrodes 74, 75.

As a different method, the potential of the uniformly-planar electrodes 72, 22 can be insulated without being set to a specific potential. However, in such a case, there is a risk that the flakes may be affected by external charges or the like.

<Effects>

As described above, according to the present embodiment, the uniformly-planar electrodes 72, 22 that face each other are provided evenly on the opposing pair of substrates 70, 20; thus, by applying a voltage between these uniformly planar electrodes 72, 22, a uniform vertical electric field is formed, thereby causing the flakes to become vertically oriented. Also, by applying a voltage between the comb-shaped electrodes 74, 75, it is possible to cause the flakes to be in a completely horizontal orientation.

In particular, when a relatively weak voltage is applied to the comb-shaped electrodes 74, 75, as shown in FIG. 13(b), the flakes move such that the surface normal thereof becomes parallel to the comb-shaped electrodes. Therefore, if the device is installed such that the comb-shaped electrodes 74, 75 extend in the up-down direction, the flakes becomes oriented such that the surface normal thereof is substantially oriented in the up-down direction when a relatively weak voltage is applied to the comb-shaped electrodes 74, 75. As a result, the invention exhibits the effect of being able to efficiently spread infrared radiation received at the culmination of the sun throughout the entire room, for example.

In the present embodiment, an example was described in which comb-shaped electrodes were formed on the substrate 70 on one side of the device. The comb-shaped electrodes may be formed on both substrates 70, 20, however. Such an example will be explained in Embodiment 5 below.

### Embodiment 5

Another embodiment of the present invention will be explained below. For ease of explanation, components having the same function as those in Embodiments 1 to 4 described above are given the same reference characters, and the descriptions thereof are omitted.

<Schematic Description of Infrared Dimming Apparatus>

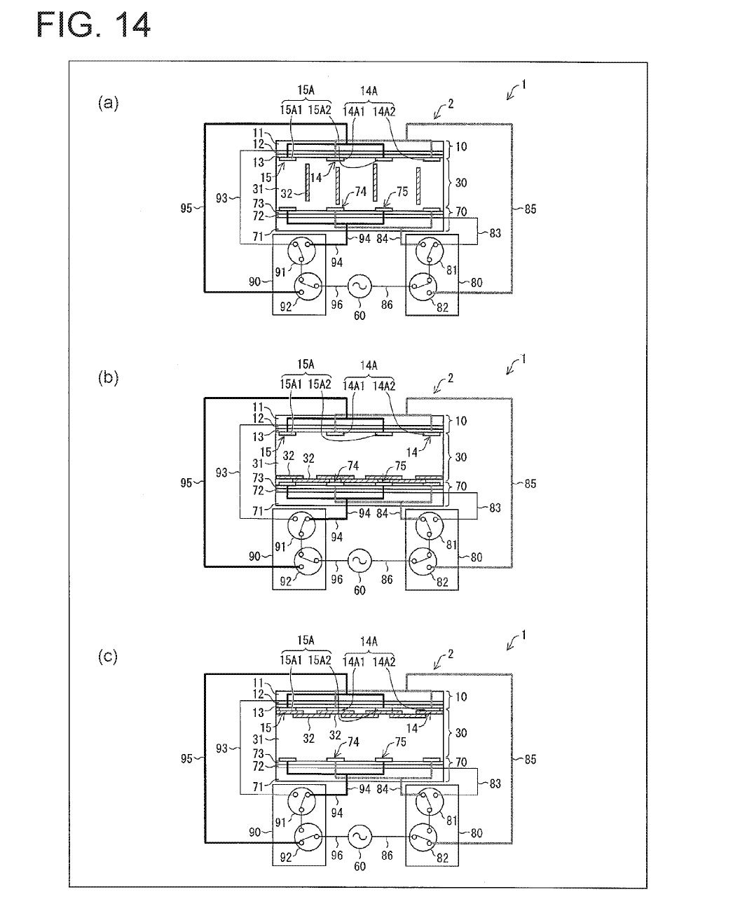

FIGS. 14(a) to 14(c) are cross-sectional views that show a schematic configuration of an infrared dimming apparatus according to the present embodiment. FIG. 14(a) shows a light-transmissive state, and FIGS. 14(b) and 14(c) show light-reflective states.

A dimming cell 2 of the present embodiment includes a pair of substrates 10, 70 disposed so as to face each other, and a light modulation layer 30 disposed between the pair of substrates 10, 70, and additionally includes relay circuits 80, 90 (switching circuits) that switch the direction of the electric field to be applied to the light modulation layer 30 by selecting to which electrodes to apply voltage, and a power source circuit 60.

That is, in the present modification example, a case is described in which the pair of opposing substrates 10, 70 are respectively active matrix substrates such as TFT substrates.

A substrate 70 is identical to the substrate 70 described in Embodiment 4; an explanation thereof will therefore be omitted. In addition, a substrate 10 is used instead of the substrate 20 described in Embodiment 4.

Similar to the substrate 70, in the substrate 10, comb-shaped electrodes 14, 15 are formed on a uniformly-planar electrode 12 formed so as to cover an insulating substrate 11.

The comb-shaped electrodes 14, 15 have the same configuration as the comb-shaped electrodes 74, 75 formed in the substrate 70. The comb-shaped electrodes 14, 15 are identical to the comb-shaped electrodes 74, 75 shown in FIG. 11, for example, and can be used in place of the comb-shaped electrodes 14, 15.

(Relay Circuits 80, 90)

The relay circuit 80 (first relay circuit) includes a first relay circuit section 81 (first switching circuit section) and a second relay circuit section 82 (second switching circuit section) that are electrically connected to each other.

Similarly, the relay circuit 90 (second relay circuit) used in the present embodiment includes a third relay circuit section 91 (third switching circuit section) and a fourth relay circuit section 92 (fourth switching circuit section) that are electrically connected to each other.

The uniformly-planar electrode 72 in the substrate 70 is electrically connected to the power source circuit 60 via the relay circuit 80, or in other words, the first relay circuit section 81 and the second relay circuit section 82. A wiring line 83 for applying voltage to the uniformly-planar electrode 72 is provided between the uniformly-planar electrode 72 and the relaycircuit 80.

The uniformly-planar electrode 12 in the substrate 10 is electrically connected to the power source circuit 60 via the relay circuit 90, or in other words, the third relay circuit section 91 and the fourth relay circuit section 92. A wiring line 93 for applying a voltage to the uniformly-planar electrode 12 is provided between the uniformly-planar electrode 12 and the relay circuit 90.

The comb-shaped electrodes 74, 75 are respectively electrically connected to the power source circuit 60 via the second relay circuit section 82 in the relay circuit 80 and the fourth relay circuit section 92 in the relay circuit 90. A wiring line 84 for applying voltage to the comb-shaped electrode 74 is provided between the comb-shaped electrode 74 and the first relay circuit section 81 of the relay circuit 80. A wiring line 94 for applying voltage to the comb-shaped electrode 75 is provided between the comb-shaped electrode 75 and the third relay circuit section 91 of the relay circuit 90.

The comb-shaped electrodes 14, 15 are respectively electrically connected to the power source circuit 60 via the second relay circuit section 82 in the relay circuit 80 and the fourth relay circuit section 92 in the relay circuit 90. A wiring line 85 for applying voltage to the comb-shaped electrode 14 is provided between the comb-shaped electrode 14 and the second relay circuit section 82 of the relay circuit 80. A wiring line 95 for applying voltage to the comb-shaped electrode 15 is provided between the comb-shaped electrode 15 and the fourth relay circuit section 92 of the relay circuit 90.

Furthermore, a wiring line 86 that connects the second relay circuit section 82 of the relay circuit 80 to the power source circuit 60 is provided between the second relay circuit section 82 and the power source circuit 60. A wiring line 96 that connects the fourth relay circuit section 92 of the relay circuit 90 to the power source circuit 60 is provided between the fourth relay circuit section 92 and the power source circuit 60.

In the present embodiment, the relay circuits 80, 90 are used to switch the electrodes to which voltage is applied from among the uniformly-planar electrodes 12, 72, the comb-shaped electrodes 14, 15, and the comb-shaped electrodes 74, 75.

In other words, the relay circuits 80, 90, the power source circuit 60, and the respective wiring lines 83 to 86 and 93 to 96 function as electric field application direction changing circuits that change the direction of the electric field applied to the light modulation layer 30, and function as voltage application units that selectively apply voltage to the respective uniformly-planar electrodes 12, 72, comb-shaped electrodes 14, 15, and comb-shaped electrodes 74, 75. The relay circuits 80, 90 function as switching circuits (selection circuits) that select (switch) electrodes to which voltage is applied from among the uniformly-planar electrodes 12, 72, the comb-shaped electrodes 14, 15, and the comb-shaped electrodes 74, 75 provided on the substrates 10, 70.

For example, as shown in FIG. 14(a), a vertical electric field perpendicular to the substrates 10, 70 is applied to the light modulation layer 30 by having the relay circuit 80 (the first relay circuit section 81 and the second relay circuit section 82) perform switching such that the power source circuit 60 and the uniformly-planar electrode 72 are connected to each other and having the relay circuit 90 (the third relay circuit section 91 and the fourth relay circuit section 92) perform switching such that the power source circuit 60 and the uniformly-planar electrode 12 are connected to each other.

As a result, the flakes rotate to a vertical orientation such that the long axes thereof are parallel to the lines of electric force due to forces explained by dielectrophoresis, Coulomb's force, or electrical energy.

As shown in FIG. 14(b), a horizontal electric field parallel to the substrate 70 is applied to the light modulation layer 30 by having the relay circuit 80 perform switching such that the power source circuit 60 is connected to the comb-shaped electrode 74 and having the relay circuit 90 perform switching such that the power source circuit 60 is connected to the comb-shaped electrode 75.

In this manner, when a voltage at or above a certain amount is applied to the comb-shaped electrodes 74, 75, which interlock with each other and are on the same plane on the rear substrate 70, the flakes orient (horizontally orient) so as to attach to the substrate 70 in the vicinity of the comb-shaped electrodes 74, 75 due to forces explained by dielectrophoresis, Coulomb's force, or electrical energy.

As shown in FIG. 14(c), a horizontal electric field parallel to the substrate 10 is applied to the light modulation layer 30 by having the relay circuit 80 perform switching such that the power source circuit 60 is connected to the comb-shaped electrode 14 and having the relay circuit 90 perform switching such that the power source circuit 60 is connected to the comb-shaped electrode 15.

In this manner, when a voltage at or above a certain amount is applied to the comb-shaped electrodes 14, 15, which interlock with each other and are on the same plane on the substrate 10 on the outside light-entering side, the flakes orient (horizontally orient) so as to attach to the substrate 10 in the vicinity of the comb-shaped electrodes 14, 15 due to forces explained by dielectrophoresis, Coulomb's force, or electrical energy.

In the present embodiment as well, the first relay circuit section 81, the second relay circuit section 82, the third relay circuit section 91, and the fourth relay circuit section 92 in the relay circuits 80, 90 may perform switching in accordance with received switching signals upon receiving such switching signals for switching the electrodes to which voltage is applied from a signal source (not shown), for example, or switching may be performed manually.

<Control of Transmittance of Infrared Light by Light Modulation Layer 30>

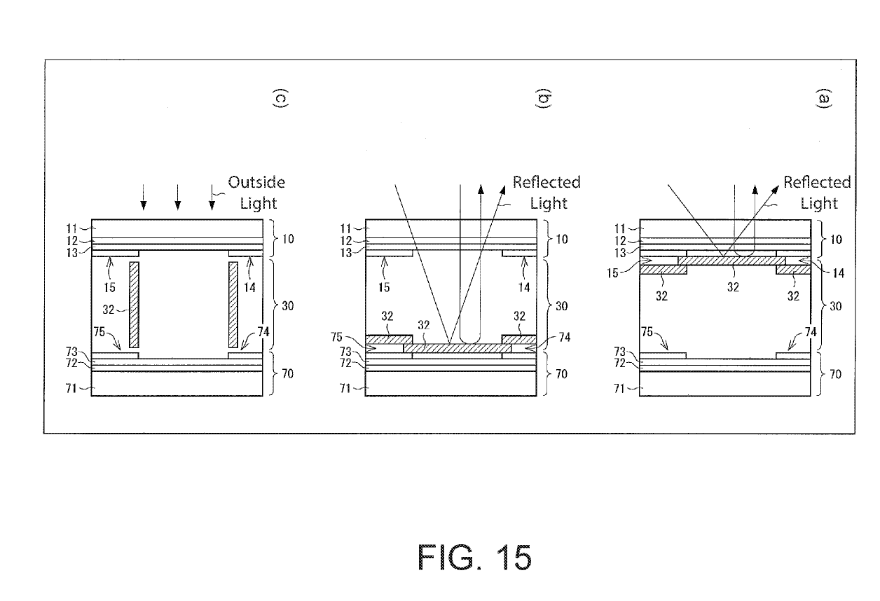

FIG. 15(a) shows the progression of light in the configuration in FIG. 14(a), FIG. 15(b) shows the progression of light in the configuration in FIG. 14(b), and FIG. 15(c) shows the progression of light in the configuration in FIG. 14(c).

In FIGS. 15(a) to 15(c), the relay circuits 80, 90 and the power source circuit 61 are not shown. In FIGS. 14(b) and 15(b), a state in which the flakes are oriented so as to attach to the substrate 70 is shown as an example, and in FIGS. 14(c) and 15(c), a state in which the flakes are oriented so as to attach to the substrate 10 is shown as an example.

Hereafter, an example will be described in which ITO flakes are used as the shape-anisotropic members 32.

As described above, if a voltage is applied between the even uniformly-planar electrodes 12, 72 that face each other, the flakes rotate to a vertical orientation such that the long axes thereof are parallel to the lines of electric force due to forces explained by dielectrophoresis, Coulomb's force, or electrical energy.

Thus, as shown in FIG. 15(a), outside light that has entered the light modulation layer 30 is transmitted by (passes through) the light modulation layer 30 and is subsequently transmitted by the substrate 70.

In contrast, as shown in FIG. 15(b), in a configuration in which the flakes are aligned on the substrate 70 side, which is opposite to the light-entering side, the outside light that entered the light modulation layer 30 from the substrate 10 is reflected by the flakes and exits from the substrate 10.

Meanwhile, as shown in FIG. 15(c), in a configuration in which the flakes are aligned on the substrate side 10, which is on the light-entering side, the outside light is reflected by the flakes without entering the light modulation layer 30 from the substrate 10, and subsequently exits from the substrate 10.

As described above, in the present embodiment, by switching the electrodes (the comb-shaped electrodes 14, 15 and the comb-shaped electrodes 74, 75) to which voltage is applied, it is possible to align the shape-anisotropic members 32 (ITO flakes, in this example) by switching the members 32 between the substrate 10 side on the outside light-entering side and substrate 70 side on the opposite side. In other words, by switching the electrodes to which voltage is applied to the comb-shaped electrodes 74, 75 formed on the substrate 70 side, as shown in FIG. 15(b), it is possible to concentrate and align the flakes on the substrate 70 side. Furthermore, by switching the electrodes to which voltage is applied to the comb-shaped electrodes 14, 15 formed on the substrate 10, as shown in FIG. 15(c), it is possible to concentrate and align the flakes on the substrate 10 side.

In cases in which comb-shaped electrodes are respectively provided on the substrate 10 on the outside light-entering side and the substrate 70 on the opposite side in this manner, the voltage applied to the respective uniformly-planar electrodes 12, 72 and comb-shaped electrodes 14, 15, 74, 75 can be set such that, in a manner similar to the case mentioned above for the uniformly-planar electrodes 12, 22 and the comb-shaped electrodes 14, 15, the comb-shaped electrodes 14, 15, 74, 75 are insulated when voltage is applied to the uniformly-planar electrodes 12, 72, the uniformly-planar electrodes 12, 72 and the comb-shaped electrodes 74, 75 are insulated when voltage is applied to the comb-shaped electrodes 14, 15, and the uniformly-planar electrodes 12, 72 and the comb-shaped electrodes 14, 15 are insulated when voltage is applied to the comb-shaped electrodes 74, 75, for example.

### Modification Example of Embodiment 5

Similar to the modification example of Embodiment 4, a pair of comb-shaped electrodes formed on one of the substrates 10, 70 may be disposed in the up-down direction, and another pair of comb-shaped electrodes may be disposed in the horizontal direction. As a result, the modification example exhibits the effect of being able to propagate infrared light in the up-down direction and the left-right direction, depending on which comb-shaped electrodes are used to control the flakes.

In Embodiments 1 to 5, a medium made of a single substance such as silicone oil, polyethylene glycol or the like, that has a high viscosity, a medium in which PMMA (polymethyl methacrylate) or the like has been mixed with the above-mentioned medium, or a material, such as silica particles, that exhibits thixotropic characteristics and that has been mixed with the above-mentioned medium, were used as the medium 31 in the light modulation layer 30. The present invention is not limited to these examples, however. An example in which liquid crystal is used as the medium 31 will be described in Embodiment 6 below.

### Embodiment 6

Another embodiment of the present invention will be explained below. For ease of explanation, components having the same function as those in Embodiments 1 to 5 described above are given the same reference characters, and the descriptions thereof are omitted.

<Infrared Dimming Apparatus>

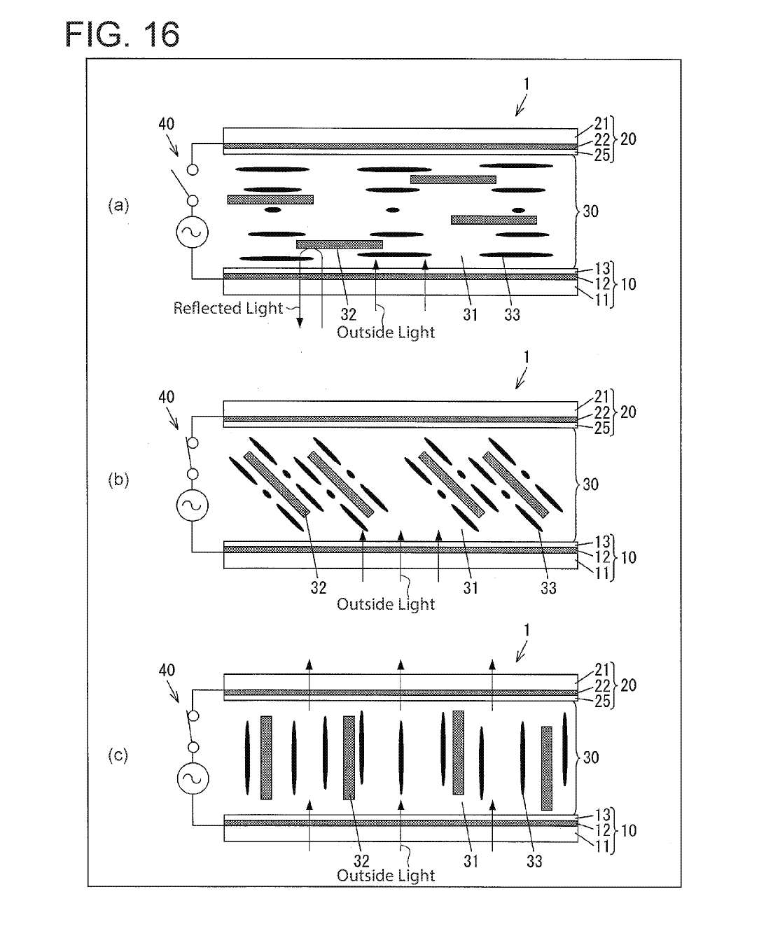

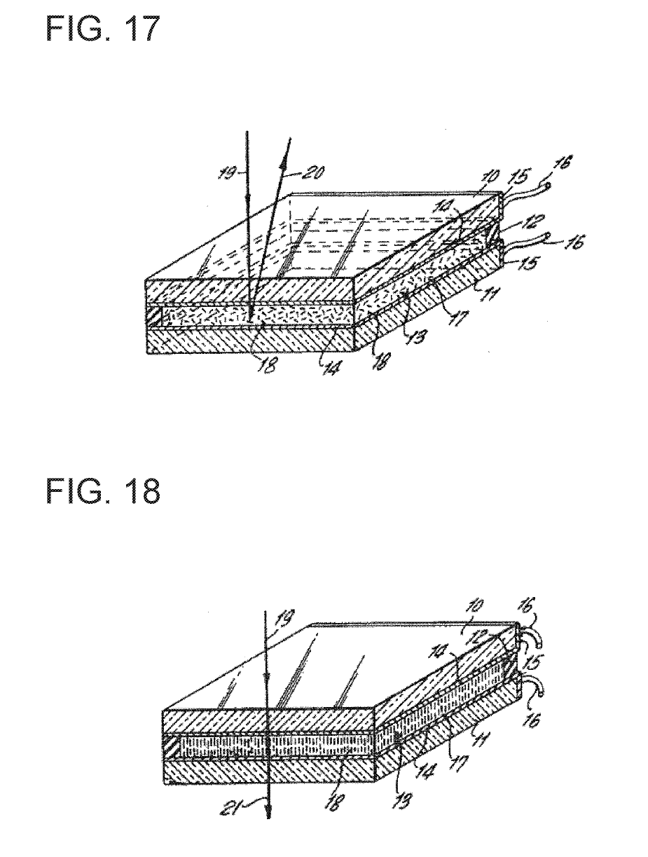

As shown in FIG. 16, an infrared dimming apparatus according to the present embodiment includes a dimmer panel 1.

<Dimmer Panel>

The dimmer panel 1 includes a pair of substrates 10, 20 arranged facing each other, and a light modulation layer 30 disposed between this pair of substrates 10, 20. The substrate 10 (a first substrate) is disposed on an outside light-entering side of the device, and the substrate 20 (a second substrate) is disposed on the outside light exiting-side of the device.

The dimmer panel 1 according to the present embodiment differs from the dimmer panel 1 of Embodiment 1 shown in FIG. 3 in that the dimmer panel 1 of the present embodiment uses liquid crystal as the medium 31. Therefore, in the dimmer panel 1 according to the present embodiment, a means for aligning the liquid crystal is formed on the substrates 10, 20.

<Substrates>

The substrate 10 includes a transparent glass substrate 11, for example, as an insulating substrate, an electrode 12, and an alignment film 13. The glass substrate 11, the electrode 12, and the alignment film 13 are stacked in this order.

The substrate 20 includes a transparent glass substrate 21, for example, as an insulating substrate, an electrode 22, and an alignment film 25. The glass substrate 21, the electrode 22, and the alignment film 25 are stacked in this order.

The substrate 10 and the substrate 20 are provided such that the respective surfaces on which the alignment films 13, 25 are formed face each other through the light modulation layer 30 therebetween.

The electrode 12 formed in the substrate 10 and the electrode 22 formed in the substrate 20 may be conductive electrode films formed of ITO (indium tin oxide) or the like.

As will be mentioned later, the alignment film 13 formed in the substrate 10 and the alignment film 25 formed in the substrate 20 undergo an alignment treatment such that liquid crystal molecules 33 included in the light modulation layer 30 are twist-aligned. Specifically, a method can be used in which a polyimide film is formed at 800 Å and then a rubbing treatment is performed on this film, for example. However, the present invention is not limited to this method, and any well-known method can be used.

It is preferable that alignment treatment be performed such that, when no voltage is being applied to the light modulation layer 30, the liquid crystal molecules 33 have a twist angle of 90° to 3600° from the substrate 10 towards the substrate 20.

<Light Modulation Layer>

The light modulation layer 30 includes liquid crystal material 31 constituted of a large number of liquid crystal molecules 33, and shape-anisotropic members 32.

Voltage is applied to the light modulation layer 30 by a power source 40 connected to the electrodes 12, 22, and the light modulation layer 30 changes the transmittance of light that has entered therein from the substrate 10 in accordance with changes in the applied voltage.

The liquid crystal material 31 has a twist orientation between the substrates 10, 20. It is possible to use chiral nematic liquid crystal in which a chiral agent has been added to nematic liquid crystal, for example. The concentration of the chiral agent depends on the type thereof and the type of the nematic liquid crystal. In an attached panel in which the orientation direction (rubbing direction) of the alignment film 13 and the orientation direction of the alignment film 25 are 90° apart and in which the thickness (cell thickness) of the light modulation layer 30 is 45 μm, the concentration of the chiral agent is adjusted such that the chiral pitch is 70 μm.

A positive type (P-type) liquid crystal having a positive dielectric anisotropy may be used as the nematic liquid crystal, or a negative type (N-type) liquid crystal having a negative dielectric anisotropy may be used as the nematic liquid crystal. In the explanations below, unless otherwise specified, P-type liquid crystal will be used.

The shape-anisotropic members 32 are members that respond to the direction of an electric field by rotating, and the liquid crystal may be oriented parallel to the surface of these members.

It is possible to select a flake shape, a columnar shape, an elliptical sphere shape, or the like, for example, as the shape of the shape-anisotropic members 32. When flakes are used, it is preferable that the thickness thereof be 1 μm or less, with 0.1 μm or less being even more preferable. When the flakes are thin, transmittance can be increased.

A metal, a semiconductor, or a dielectric can be used as the material for the flakes, or a composite material of these may be used. If a metal is used, it is possible to select aluminum flakes that are used for coating, for example.

Furthermore, the flakes may be formed via a colored member, or may be formed via ITO (indium tin oxide) flakes, a dielectric multilayer film such as a multilayer film of SiO₂ and TiO₂, or a cholesteric resin. In all cases, however, it is necessary that the liquid crystal be oriented parallel to the surface of these members. “Parallel” does not necessarily mean strictly parallel, and may mean substantially parallel.

Treatment is not particularly necessary when using a material with a high surface tension such as a cholesteric resin or a metal, for example, in order to align the liquid crystal molecules 33 parallel to the surface of the shape-anisotropic members 32. However, when using a substance that is hydrophobic and in which the liquid crystal molecules 33 do not orient parallel to the surface of the shape-anisotropic members 32, it is necessary to form a resin film or the like by using a method such as dip-coating.

The specific gravity of the shape-anisotropic members 32 is preferably 11 g/cm³ or less, with 3 g/cm³ being more preferable, and being equal to the specific gravity of the liquid crystal material 31 being even more preferable. This is because when the specific gravity of these members differs greatly from that of the liquid crystal material 31, the shape-anisotropic members 32 settle out.

<Orientation Control Of Shape-Anisotropic Members>

Next, a method of controlling the orientation of the flakes will be described in more detail using FIG. 16. FIG. 16 shows the orientation of the flakes used as the shape-anisotropic members 32 and a portion of the liquid crystal molecules 33 in the liquid crystal material 31.

The orientation direction of the alignment film 25 in a plan view is at a 180° angle to the orientation direction of the alignment film 13. This twists the liquid crystal molecules 33 into a spiral shape perpendicular to the surfaces of the substrate 10 and the substrate 20 when no voltage is being applied to the light modulation layer 30. The liquid crystal molecules 33 are disposed so as to have mutually different long-axis directions and are separated at a uniform distance in at least the direction perpendicular to the surface of the substrates.

P-type liquid crystal is used as the liquid crystal material 31.

FIG. 16(a) shows the orientation of the flakes and the liquid crystal molecules 33 when voltage is not being applied to the light modulation layer 30. FIGS. 16(b) and 16(c) show the orientation of the flakes and the liquid crystal molecules 33 when voltage is being applied to the light modulation layer 30.

The voltage applied to the light modulation layer 30 as shown in FIG. 16(b) is controlled via a drive circuit (not shown) such that the voltage becomes lower (smaller) than the voltage applied to the light modulation layer 30 as shown in FIG. 16(c).

As shown in FIG. 16(a), when voltage is not being applied to the light modulation layer 30, the liquid crystal molecules 33 are oriented so as to have a spiral axis that is perpendicular to the surfaces of the substrates 10, 20 and that is oriented along the orientation direction of the alignment films 13, 25. In other words, the liquid crystal molecules 33 are twisted at a 180° angle between the substrates 10, 20.

Furthermore, the flakes move such that the liquid crystal molecules 33 are oriented parallel to the surface of the flakes, resulting in the flakes being oriented such that the surface thereof becomes parallel to the surface of the substrates. In other words, the flakes become horizontally oriented.

The flakes are supported in two directions (two axes) by the liquid crystal molecules 33 on one surface and the liquid crystal molecules 33 on the other surface. This causes the flakes to be held by restraining force from the liquid crystal molecules 33 and to horizontally orient.

As shown in FIG. 16(b), when voltage is applied to the light modulation layer 30, as the voltage is being applied to the light modulation layer 30, the angle between the long axes of the liquid crystal molecules 33 and the surfaces of the substrates becomes larger in accordance with the applied voltage.

The flakes rotate such that the long axes thereof approach a position parallel to the lines of electric force and become vertically oriented due to forces explained by dielectrophoresis, Coulomb's force, or electrical energy, and due to forces that make the interface energy with the liquid crystal very small.

This also causes a change in the orientation of the flakes and a change in the angle between a line perpendicular to the surface of the flakes having the largest area and a line perpendicular to the surfaces of the substrates 10, 20.

As shown in FIG. 16(c), when a voltage of greater than or equal to certain amount is applied to the light modulation layer 30, the liquid crystal molecules 33 orient such that the long axes thereof become perpendicular to the surfaces of the substrates 10, 20.

This causes the line perpendicular to the surface of the flakes having the largest area and the line perpendicular to the surfaces of the substrates 10, 20 to become perpendicular to each other.

When using P-type liquid crystal as the liquid crystal material 31, the tilt of the liquid crystal molecules 33 with respect to the surfaces of the substrates takes an intermediate state in accordance with the amount of voltage applied to the light modulation layer 30; therefore, the tilt of the flakes with respect to the surfaces of the substrates can also take an intermediate state.

This allows an amount of light corresponding to the amount of voltage applied to the light modulation layer to pass through, and makes it possible to easily control the transmittance of infrared light in the dimmer panel 1.

In all of the above-mentioned embodiments, a UV reflective film (not shown) or a UV absorbing film (not shown) may be formed on the infrared light-entering side of the dimming cell 2. As a result, when a material that absorbs UV rays is used in the dimming cell 2 (such as when a material such as liquid crystal that absorbs UV rays is used as the medium, for example), the present invention exhibits the effect of being able to prevent the medium from deteriorating.

<Summary>

An infrared dimming apparatus according to a first aspect of the present invention includes a dimming layer (dimming cell 2) that has a plurality of shape-anisotropic members 32 that are disposed between a pair of substrates 10, 20 facing each other and that reflect infrared light, the dimming layer adjusting the transmittance of received infrared light; and a state switching control unit (automatic control circuit 4) that, by applying voltage to the dimming layer, changes the projected area of shape-anisotropic members on the pair of substrates and controls the switching between an infrared reflective state and an infrared transmissive state. The state switching control unit controls the switching between the infrared reflective state and the infrared transmissive state in the dimming layer in accordance with a predetermined time schedule.

In the above-mentioned configuration, the reflection and transmission of infrared light is controlled by the orientation state of the shape-anisotropic members, which reflect infrared light; thus, when infrared light is reflected, the interior of the dimming layer does not become warmer since the infrared light is appropriately reflected by the shape-anisotropic members. Since the infrared light is reflected by the shape-anisotropic members, it is possible to appropriately reflect infrared light in accordance with the orientation state of the shape-anisotropic members; thus, infrared light will not be emitted in an undesired direction from the dimming layer. As a result, there will not be an increase in the temperature inside the dimming layer itself resulting from the scattering of infrared light when the infrared light is reflected.

Furthermore, since the switching between the infrared reflective state and the infrared transmissive state in the dimming layer is performed in accordance with a predetermined time schedule, it is possible to automatically perform the switching between the infrared reflective state and the infrared transmissive state in the dimming layer.

In a case such as that in which the transmittance of infrared light is controlled by attaching an outside light dimming device with the present configuration to a window in a house, infrared light is reflected in the dimming layer during the day in summer by aligning the shape-anisotropic members in a horizontal orientation, infrared light is transmitted in the dimming layer during summer nights by aligning the shape-anisotropic members in a vertical orientation, infrared light is transmitted in the dimming layer during the day in summer by aligning the shape-anisotropic members in a vertical orientation, and infrared light is reflected in the dimming layer during winter nights by aligning the shape-anisotropic members in a horizontal orientation, for example.

As a result, it is possible to prevent the temperature inside the home from increasing or decreasing too much even when the alignment of the shape-anisotropic members is not being intentionally controlled, such as when no one is home; thus, it is possible to reduce the amount of time and energy it takes to reach the preset temperature entered into an air conditioner/heater, and it is also possible to reduce the deterioration of products inside the home, such as wallpaper, and electronic devices, for example. In addition, when an air conditioner/heater is being used, it is possible to manually align the shape-anisotropic members in a horizontal orientation when an air conditioner has been turned on during a summer night, for example.

An infrared dimming apparatus according to a second aspect of the present invention is characterized by, in the first aspect, the state switching control unit changing the projected area of the shape-anisotropic members on the pair of substrates by changing the frequency of the voltage applied to the dimming layer.

In the above-mentioned configuration, the transmittance of light is changed by changing the frequency of the voltage applied to the dimming layer. Thus, it is possible to realize a display panel having high light usage efficiency with a simple configuration.

An infrared dimming apparatus according to a third aspect of the present invention is characterized by, in the first or second aspect, the dimming layer including a polar solvent, a non-polar solvent, and a plurality of shape-anisotropic members that are hydrophobic or hydrophilic, one of the pair of substrates being hydrophilic and contacting the polar solvent, and the other of the pair of substrates being hydrophobic and contacting the non-polar solvent.

In the above-mentioned configuration, when voltage is not applied to the dimming layer, the shape-anisotropic members can be aligned (horizontally aligned) in the polar solvent if the shape-anisotropic members are hydrophilic, and the shape-anisotropic members can be aligned (horizontally aligned) in the non-polar solvent if the shape-anisotropic members are hydrophobic. In addition, when a voltage is applied to the dimming layer, it is possible to change the projected area of the shape-anisotropic members on the first and second substrates.

In this manner, by making the shape-anisotropic members, which are disposed between a hydrophilic substrate and a hydrophobic substrate, hydrophilic or hydrophobic, it is possible to keep the shape-anisotropic members within the polar solvent or the non-polar solvent when no voltage is being applied, and to transmit light when voltage is being applied. Thus, it is possible to realize a display panel having high light usage efficiency with a simple configuration.

An infrared dimming apparatus according to a fourth aspect of the present invention includes, in any one of the first to third aspects, one or more supporting members that are provided on at least one of the pair of substrates and that support each of the plurality of shape-anisotropic members. Each of the plurality of shape-anisotropic members is connected to the supporting members so as to be rotatable.

In the above-mentioned configuration, the shape-anisotropic members are connected to the supporting members (flakes) so as to be rotatable; thus, the shape-anisotropic members do not become unevenly distributed within the surface. In addition, by changing the transmittance of light by rotating the shape-anisotropic members, it is possible to increase the light usage efficiency.

An infrared dimming apparatus according to a fifth aspect of the present invention is characterized by, in the any one of the first to fourth aspects, the pair of substrates including a uniformly-planar electrode on respective opposing faces, and at least one comb-shaped electrode being provided in at least one of the pair of substrates on the uniformly-planar electrode with an insulating layer interposed therebetween.

In the above-mentioned configuration, by including even uniformly-planar electrodes that face each other on a pair of opposing substrates, when voltage is applied between these uniformly-planar electrodes, the long axes of the shape-anisotropic members vertically orient so as to become perpendicular to the pair of substrates as a result of a uniform vertical electric field (in other words, a uniform electric field in a direction perpendicular to the pair of substrates).

Therefore, when the vertical electric field is generated, there are no areas where the electric field is weak, and the shape-anisotropic members can be vertically aligned without aggregation occurring.

An infrared dimming apparatus according to a sixth aspect of the present invention is characterized by, in any one of the first to fifth aspects: the dimming layer further including liquid crystal material made of liquid crystal molecules; the pair of substrates undergoing alignment treatment on respective surfaces facing the dimming layer; the alignment treatment being performed such that, when no voltage is being applied to the dimming layer, the liquid crystal molecules become twisted from one side of the one substrate to another side or the liquid crystal molecules becoming aligned substantially perpendicular to the pair of substrates; and changing the projected area of the shape-anisotropic members on the pair of substrates by changing the voltage applied to the dimming layer and changing the orientation of the liquid crystal molecules.

In this configuration, the voltage applied to the dimming layer is changed in order to change the orientation of the liquid crystal molecules, thereby making it possible to change the transmittance of light. Polarizing plates are not necessary, which makes it possible to increase light usage efficiency compared to a display panel that uses polarizing plates.

When voltage is not being applied to the dimming layer, or when the amount of voltage being applied is small, the orientation of the liquid crystal molecules is determined by the alignment treatment performed on the substrates; therefore, it is possible reversibly change the orientation of the shape-anisotropic members.

As a result, it possible to increase light usage efficiency with a simple configuration.

An infrared dimming apparatus according to a seventh aspect of the present invention is characterized by, in any one of the first to sixth aspects: the shape-anisotropic members being formed of flake-shaped members; and, when the dimming layer is in an infrared transmissive state, the flake-shaped members being disposed such that the flake surface normal of the flake-shaped members becomes parallel to the pair of substrates.

In such a configuration, the received light can be transmitted without any interference from the flakes, and the light received from a direction not parallel to the flake surface can be reflected by the flake surface, reoriented, and thereafter transmitted. In this manner, infrared light coming directly from the winter sun, for example, not only illuminates the floor surface but is dispersed throughout the entire room; thus it is possible to efficiently raise the temperature inside the room. This dispersion effect becomes even larger when flakes having recesses and protrusions are used.

An infrared dimming apparatus according to an eighth aspect of the present invention is characterized by, in any one of the first to seventh aspects, a UV-reflective film or a UV-absorbing film being formed on the infrared light-entering side of the dimming layer.

In the above-mentioned configuration, when a material that absorbs UV rays is used in the dimming layer, it is possible prevent deterioration of a medium when a material such as liquid crystal that absorbs UV rays is used as the medium, for example.

### INDUSTRIAL APPLICABILITY

The present invention can be suitably applied to a room temperature control device that performs temperature control within a room that receives infrared light.

### DESCRIPTION OF REFERENCE CHARACTERS

1 dimmer panel

2 dimming cell

3 power source circuit

4 automatic control circuit (state switching control unit)

5 manual control circuit

6 storage unit

7 operation unit

10 substrate

11 glass substrate (insulating substrate)

12 uniformly-planar electrode

13 alignment film

14 comb-shaped electrode

15 comb-shaped electrode

20 substrate

21 glass substrate

22 uniformly-planar electrode

24 rib

25 alignment film

30 light modulation layer

31 liquid crystal material (medium)

31a polar solvent

31b non-polar solvent

32 shape-anisotropic member (flake)

33 liquid crystal molecule

34 supporting member

40 power source

41 relay circuit

42 to 44 wiring line

51 relay circuit

52 to 54 wiring line

60 power source circuit

61 power source circuit

70 substrate

71 insulating substrate

72 uniformly-planar electrode

73 insulating layer

74 comb-shaped electrode

74A branch electrode

74B trunk electrode

74L electrode section

74S space

75 comb-shaped electrode

75A branch electrode

75B trunk electrode

75L electrode section

75S space

80 relay circuit

81 first relay circuit section

82 relay circuit section

82 second relay circuit section

83 to 86 wiring line

90 relay circuit

91 third relay circuit section

92 relay circuit section

92 circuit section

92 fourth relay circuit section

93 to 96 wiring line

1. An infrared dimming apparatus, comprising:
a dimming layer including a plurality of shape-anisotropic members that are disposed between a pair of substrates opposing each other and that have reflective characteristics with respect to infrared light, so as to adjust transmittance of received infrared light; and
a state switching control unit that applies a voltage to the dimming layer to change an area covered by the shape-anisotropic member as seen from a direction normal to the pair of substrates, so as to control switching between an infrared reflective state and an infrared transmissive state in the dimming layer,
wherein the state switching control unit controls the switching between the infrared reflective state and the infrared transmissive state in the dimming layer in accordance with a predetermined time schedule.

2. The infrared dimming apparatus according to claim 1, wherein the state switching control unit changes a frequency of the voltage applied to the dimming layer to change the area covered by the shape-anisotropic member as seen from the direction normal to the pair of substrates.

3. The infrared dimming apparatus according to claim 1,
wherein the dimming layer includes a polar solvent, a non-polar solvent, and the plurality of shape-anisotropic members, the shape-anisotropic members being hydrophilic or hydrophobic,
wherein one of the pair of substrates is hydrophilic and contacts the polar solvent, and
wherein another of the pair of substrates is hydrophobic and contacts the non-polar solvent.

4. The infrared dimming apparatus according to claim 1,
wherein each of the pair of substrates includes a uniformly-planar electrode on a surface that opposes the other substrate, and
wherein, on at least one of the pair of substrates, one or more comb-shaped electrodes are provided on the uniformly-planar electrode with an insulating layer interposed therebetween.

5. The infrared dimming apparatus according to claim 1,
wherein the shape-anisotropic members are formed of flake-shaped members, and
wherein, when the dimming layer is in the infrared transmissive state, the flake-shaped members are disposed such that a line normal to a flake surface of the flake-shaped members is parallel to the pair of substrates.

6. The infrared dimming apparatus according to claim 2,
wherein the dimming layer includes a polar solvent, a non-polar solvent, and the plurality of shape-anisotropic members, the shape-anisotropic members being hydrophilic or hydrophobic,
wherein one of the pair of substrates is hydrophilic and contacts the polar solvent, and
wherein another of the pair of substrates is hydrophobic and contacts the non-polar solvent.

7. The infrared dimming apparatus according to claim 2,
wherein each of the pair of substrates includes a uniformly-planar electrode on a surface that opposes the other substrate, and
wherein, on at least one of the pair of substrates, one or more comb-shaped electrodes are provided on the uniformly-planar electrode with an insulating layer interposed therebetween.

8. The infrared dimming apparatus according to claim 3,
wherein each of the pair of substrates includes a uniformly-planar electrode on a surface that opposes the other substrate, and
wherein, on at least one of the pair of substrates, one or more comb-shaped electrodes are provided on the uniformly-planar electrode with an insulating layer interposed therebetween.

9. The infrared dimming apparatus according to claim 6,
wherein each of the pair of substrates includes a uniformly-planar electrode on a surface that opposes the other substrate, and
wherein, on at least one of the pair of substrates, one or more comb-shaped electrodes are provided on the uniformly-planar electrode with an insulating layer interposed therebetween.

10. The infrared dimming apparatus according to claim 2,
wherein the shape-anisotropic members are formed of flake-shaped members, and
wherein, when the dimming layer is in the infrared transmissive state, the flake-shaped members are disposed such that a line normal to a flake surface of the flake-shaped members is parallel to the pair of substrates.

11. The infrared dimming apparatus according to claim 3,
wherein the shape-anisotropic members are formed of flake-shaped members, and
wherein, when the dimming layer is in the infrared transmissive state, the flake-shaped members are disposed such that a line normal to a flake surface of the flake-shaped members is parallel to the pair of substrates.

12. The infrared dimming apparatus according to claim 4,
wherein the shape-anisotropic members are formed of flake-shaped members, and
wherein, when the dimming layer is in the infrared transmissive state, the flake-shaped members are disposed such that a line normal to a flake surface of the flake-shaped members is parallel to the pair of substrates.

13. The infrared dimming apparatus according to claim 6,
wherein the shape-anisotropic members are formed of flake-shaped members, and
wherein, when the dimming layer is in the infrared transmissive state, the flake-shaped members are disposed such that a line normal to a flake surface of the flake-shaped members is parallel to the pair of substrates.

14. The infrared dimming apparatus according to claim 7,
wherein the shape-anisotropic members are formed of flake-shaped members, and
wherein, when the dimming layer is in the infrared transmissive state, the flake-shaped members are disposed such that a line normal to a flake surface of the flake-shaped members is parallel to the pair of substrates.

15. The infrared dimming apparatus according to claim 8,
wherein the shape-anisotropic members are formed of flake-shaped members, and
wherein, when the dimming layer is in the infrared transmissive state, the flake-shaped members are disposed such that a line normal to a flake surface of the flake-shaped members is parallel to the pair of substrates.

16. The infrared dimming apparatus according to claim 9,
wherein the shape-anisotropic members are formed of flake-shaped members, and
wherein, when the dimming layer is in the infrared transmissive state, the flake-shaped members are disposed such that a line normal to a flake surface of the flake-shaped members is parallel to the pair of substrates.
